(19) United States
(12) Patent Application Publication
(10) Pub. No.: US 2016/0255047 A1
(43) Pub. Date: Sep. 1, 2016

(54) METHODS AND SYSTEMS FOR DETERMINING DOMAIN NAMES AND ORGANIZATION NAMES ASSOCIATED WITH PARTICIPANTS INVOLVED IN SECURED SESSIONS

(71) Applicant: Citrix Systems, Inc., Fort Lauderdale, FL (US)

(72) Inventor: Kannan PARTHASARATHY, Palo Alto, CA (US)

(21) Appl. No.: 14/632,913

(22) Filed: Feb. 26, 2015

(51) Int. Cl. H04L 29/12

(52) U.S. Cl. CPC H04L 61/3015; H04L 61/6004

(57) ABSTRACT

An apparatus is provided for determining at least one of a domain name and an organization name associated with a server. The apparatus can include a traffic processor configured to acquire one or more handshake messages associated with establishing or resuming a secure session with the server. The apparatus can also include a site detector configured to determine whether the one or more handshake messages include one or more site textual identifiers. If the one or more handshake messages does not include one or more site textual identifiers, the site detector is configured to acquire the at least one of a domain name and an organization name based on querying a historical identification database using at least one of a session identifier and an IP address associated with the server.

### BACKGROUND

The recent few years has witnessed an explosive growth of data traffic in networks, particularly in cellular wireless networks. This growth has been fueled by a number of new developments that includes faster, smarter and more intuitive mobile devices such as the popular iPhone® series and the iPad® series, as well as faster wireless and cellular network technologies that deliver throughputs on par or better than fixed line broadband technologies.

For many people today, a primary mode of access to the Internet is via mobile devices using cellular wireless networks. Users have come to expect the same quality of experience as in fixed line broadband networks. To meet this insatiable demand, wireless network operators are taking a number of steps such as installing additional cell towers in congested areas, upgrading the backhaul network infrastructure that connects the base stations with the packet core, and deploying newer radio access technologies such as Dual-Cell High Speed Downlink Packet Access (DC-HSDPA) and Long Term Evolution (LTE). While these approaches help with meeting the demand for quality of experience, the slow pace at which major network upgrades can be made is not keeping up with the rate at with data traffic is growing. Furthermore, the cost of such network upgrades is not commensurate with the revenue per subscriber that the wireless operator is able to get, i.e., the cost being much higher than any increase in revenue the wireless operator can expect. Faced with these challenges, cellular wireless network operators across the globe are introducing various traffic management techniques to control the growth of data traffic and increase their revenues at the same time.

Traffic Management is a broad concept and includes techniques such as throttling of low priority traffic, blocking or time shifting certain types of traffic, and traffic optimization. Optimization of web and video traffic is a key component in the array of traffic management techniques used by wireless operators. Web traffic refers to traditional web site browsing, and video traffic refers to watching videos over the Internet—between the two, web and video traffic account for more than 80% of the data traffic in typical cellular wireless networks.

### BRIEF DESCRIPTION OF THE DRAWINGS

FIG. 1 is a block diagram of an exemplary network system, consistent with embodiments of the present disclosure.

FIGS. 2A-2B are diagrams of exemplary message flows between a client and a server, consistent with embodiments of the present disclosure

FIG. 3 is a block diagram illustrating an embodiment of an exemplary adaptive traffic manager, consistent with embodiments of the present disclosure.

FIG. 4 is a flowchart representing an exemplary method for determining domain name information based on handshake messages associated with a secured session, consistent with embodiments of the present disclosure

FIGS. 5A-5B are diagrams illustrating an exemplary hierarchy tree for organizing historical identifications, consistent with embodiments of the present disclosure.

FIGS. 6A-6C are block diagrams illustrating exemplary data structures for accessing and updating historical identifications, consistent with embodiments of the present disclosure.

FIG. 7 is a flowchart representing an exemplary method for determining domain name information from handshake messages associated with establishing a secured session, consistent with embodiments of the present disclosure.

FIGS. 8A-8E are flowcharts representing exemplary methods for updating the historical identifications, consistent with embodiments of the present disclosure.

FIG. 9 is a flowchart representing an exemplary method for determining a domain name from handshake messages associated with resuming a secured session, consistent with embodiments of the present disclosure.

FIG. 10 is a flowchart representing an exemplary method for determining an organization name from handshake messages associated with resuming a secured session, consistent with embodiments of the present disclosure.

FIG. 11 is a flowchart representing an exemplary method for determining an organization name from handshake messages associated with resuming a session, consistent with embodiments of the present disclosure.

### DETAILED DESCRIPTION

Reference will now be made in detail to the exemplary embodiments consistent with the embodiments disclosed herein, the examples of which are illustrated in the accompanying drawings. Wherever possible, the same reference numbers will be used throughout the drawings to refer to the same or like parts.

The present disclosure provides an apparatus for determining a domain name and/or an organization name associated with a server. In some embodiments, the apparatus comprises a traffic processor configured to acquire one or more handshake messages associated with establishing or resuming a session with the server. The apparatus also includes a site detector configured to determine whether the one or more handshake messages include one or more site textual identifiers.

If the one or more handshake messages include one or more site textual identifiers, the site detector is configured to determine a domain name and/or an organization name associated with the server based on the site textual identifiers, to store the determined domain name and/or organization name at a historical identification database, and to associate the determined domain name and/or organization name with the at least one key at the historical identification database.

If the one or more handshake messages do not include one or more site textual identifiers, the site detector is configured to acquire at least one of a domain name and an organization name based on querying a historical identification database using at least one of a session identifier and an IP address associated with the server.

The apparatus can determine a domain name or an organization name associated with a server, based on site textual identifiers included in the handshake messages. This is because site textual identifiers can provide more information than just a numerical identifier (e.g., an IP address) associated with the server. For example, the site textual identifier can include information that reflects the actual domain name of the server, or at least the domain structure that the server is located within. The site textual identifier can also include information that reflects the name of an organization that operates the server. Some or all these information can be used for, for example, determining a traffic management or optimization policy for a particular session.

Moreover, by storing the previously-determined (historical) domain name and/or organization name, these information can also be retrieved for a later session, if the handshake messages for the later session do not include the site textual identifiers. The historical domain name and/or organization name can be associated with at least one key generated from one of the IP address and a session identifier. If the later session is also associated with the same IP address and/or the same session identifier, the IP address and/or the session identifier can be used to retrieve the historical determined domain name and/or organization name.

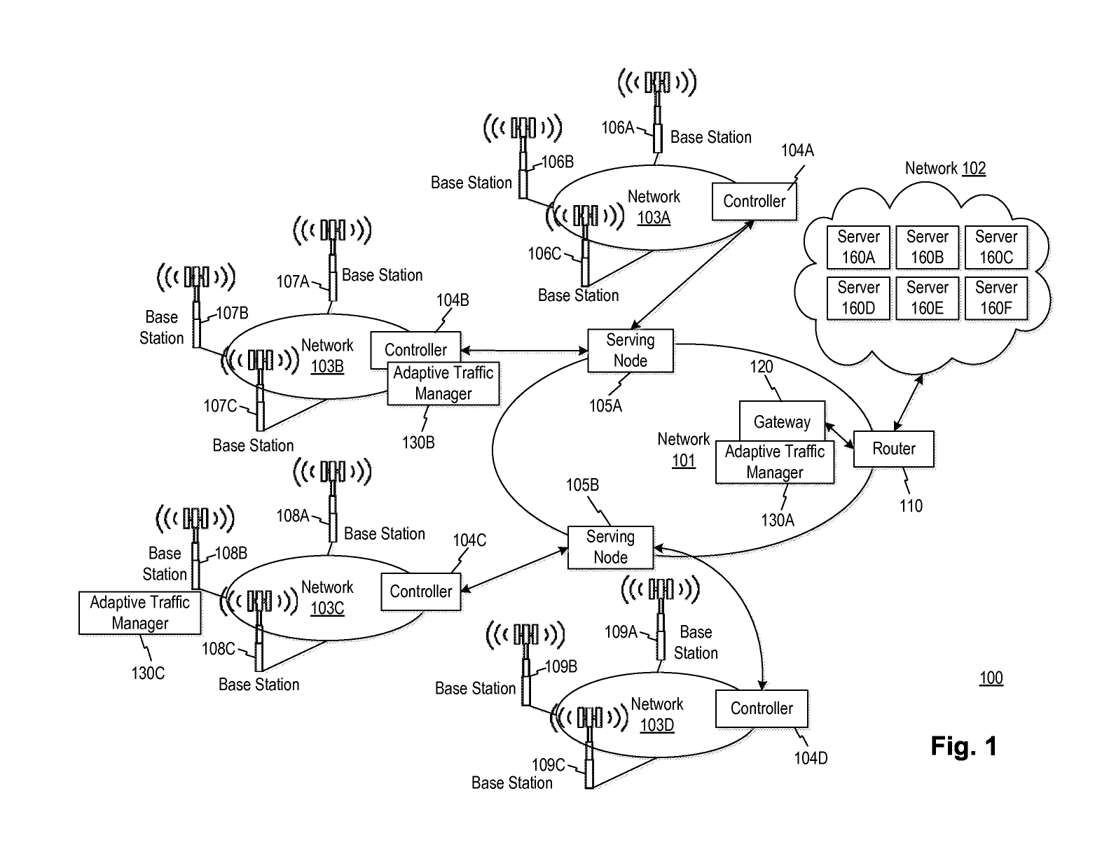

Network congestion or overload conditions in networks are often localized both in time and space and affect only a small set of users at any given time. This can be caused by the topology of communication systems. In an exemplary cellular communication system, such as the system shown in FIG. 1, the system can have a tree-like topology, with a router or a gateway being the root of the tree and the mobile base stations being the leaves. This tree-like topology is similar across cellular technologies including Global System for Mobile Communication (GSM), Universal Mobile Telecommunications System (UMTS) adopting Wideband Code Division Multiple Access (W-CDMA) radio access technology, CDMA2000, Worldwide Interoperability for Microwave Access (WiMax) and Long Term Evolution (LTE). In a tree-like structure of a wireless network, the impact of network overload conditions depends on the level of aggregation in the network where that overload condition occurs. For example, an overload condition at a base station level affects only those users who are connected to that base station. Therefore, in some embodiments, an adaptive traffic manager identifies the aggregation level at which an overload condition occurs, and then applies traffic management techniques in a holistic fashion across only those users that are affected by the overload condition.

Adaptive traffic management is an approach wherein traffic management techniques such as web and video optimization can be applied selectively based on monitoring key indicators that have an impact on the Quality of Experience (QoE) of users or subscribers. Applying optimization can involve classifying content data based on perceived information about a type of service provided by the server. For example, a domain name of a server can indicate that it is serving video data. A subscriber can be a mobile terminal user who subscribes to a wireless or cellular network service. While the subscriber refers to the mobile terminal user here, future references to subscriber can also refer to a terminal that is used by the subscriber, or refer to a client device used by the subscriber.

FIG. 1 is a block diagram of an exemplary network system. Exemplary communication system 100 can be any type of system that transmits data packets over a network. For example, the exemplary communication system 100 can include one or more networks transmitting data packets across wired or wireless networks to terminals (terminals not shown in FIG. 1). The exemplary communication system 100 can have network architectures of, for example, a GSM network, a UMTS network that adopts Wideband Code Division Multiple Access (W-CDMA) radio access technology, a CDMA2000 network, and a WiMax network.

The exemplary communication system 100 can include, among other things, one or more networks 101, 102, 103(A-D), one or more controllers 104(A-D), one or more serving nodes 105(A-B), one or more base stations 106(A-D)-109(A-D), a router 110, a gateway 120, and one or more adaptive traffic managers 130(A-C). At a high level, the network topology of the exemplary communication system 100 can have a tree-like topology with gateway 120 being the tree's root node and base stations 106-109 being the leaves.

Router 110 is a device that is capable of forwarding data packets between networks, creating an overlay internetwork. Router 110 can be connected to two or more data lines from different networks. When a data packet comes in on one of the lines, router 110 can determine the ultimate destination of the data packet and direct the packet to the next network on its journey. In other words, router 110 can perform “traffic directing” functions. In the exemplary embodiment shown in FIG. 1, router 110 communicates with network 102 and gateway 120. Router 110 directs traffic from the network 102 to the gateway 120 and vice versa.

Network 101 can be any combination of radio network, wide area networks (WANs), local area networks (LANs), or wireless networks suitable for packet-type communications, such as Internet communications. For example, in one exemplary embodiment, network 101 can be a General Packet Radio Service (GPRS) core network, which provides mobility management, session management and transport for Internet Protocol packet services in GSM and W-CDMA networks. The exemplary network 101 can include, among other things, a gateway 120, and one or more serving nodes 105(A-B).

Gateway 120 is a device that converts formatted data provided in one type of network to a particular format required for another type of network. Gateway 120, for example, may be a server, a router, a firewall server, a host, or a proxy server. Gateway 120 has the ability to transform the signals received from router 110 into a signal that network 101 can understand and vice versa. Gateway 120 may be capable of processing webpage, image, audio, video, and T.120 transmissions alone or in any combination, and is capable of full duplex media translations. As an exemplary embodiment, gateway 120 can be a Gateway GPRS Support Node (GGSN) that supports interworking between the GPRS network and external packet switched networks, like the Internet and X.25 networks.

Serving nodes 105 are devices that deliver data packets from gateway 120 to a corresponding network 103 within its geographical service area and vice versa. A serving node 105 can be a server, a router, a firewall server, a host, or a proxy server. A serving node 105 can also have functions including packet routing and transfer, mobility management (attach/detach and location management), logical link management, network access mediation and authentication, and charging functions. As an exemplary embodiment, a serving node 105 can be a Serving GPRS Support Node (SGSN). SGSN can have location register, which stores location information, e.g., current cell, current visitor location (VLR) and user profiles, e.g., International Mobile Subscriber Identity (IMSI), and addresses used in the packet data network, of all GPRS users registered with this SGSN.

Network 102 can include any combination of wide area networks (WANs), local area networks (LANs), or wireless networks suitable for packet-type communications. In some exemplary embodiments, network 102 can be, for example, Internet and X.25 networks. Network 102 can communicate data packet with network 101 with or without router 110. In some embodiments, network 102 can be associated with servers 160(A-F), each of which can be associated a host name or domain name. In the present disclosure, the term “server” can be a physical or virtual machine. A server can also be a service that is provided by a collection of individual physical or virtual machines that interface with a load balancer. The load balancer can provide one or more virtual IP addresses to the clients. The collection of servers 160(A-F) can be operated by an organization (e.g., ABC Travel Related Service Inc.), and the domain names associated with servers 160(A-F) can be organized under a domain hierarchy tree, which is further discussed in more detail below.

Networks 103 can include any radio transceiver networks within a GSM or UMTS network or any other wireless networks suitable for packet-type communications. In some exemplary embodiments, depending on the underlying transport technology being utilized, the Radio Access Network (RAN) or Backhaul area of network 103 can have a ring topology. In some embodiments, network 103 can be a RAN in a GSM system or a Backhaul area of a UMTS system. The exemplary network 103 can include, among other things, base stations 106-109 (e.g., base transceiver stations (BTSs) or Node-Bs), and one or more controllers 104(A-C) (e.g., base-station controllers (BSCs) or radio network controllers (RNCs)). Mobile terminals (not shown in FIG. 1) communicate with BTS/Node-B 106-109 which have radio transceiver equipment. BTS/Node-B 106-109 communicate with BSC/RNC 104(A-C), which are responsible for allocation of radio channels and handoffs as users move from one cell to another. The BSC/RNC 104(A-C) in turn communicate to serving nodes 105, which manage mobility of users as well as provide other functions such as mediating access to the network and charging.

As shown in FIG. 1, adaptive traffic manager 130 can be deployed at one or more locations within communication system 100, including various locations within network 101 and 103. In some embodiments, adaptive traffic manager 130 can be located at gateway 120, at controller 104, at one or more base stations 106-109, or any other locations. Adaptive traffic manager 130 can be either a standalone network element or can be integrated into existing network elements such as gateway 120, controllers 104, and base stations 106-109. Adaptive traffic manager 130 can continuously monitor several parameters of communication system 100. The parameters can be used to generate traffic management rules. The traffic management rules are generated dynamically and change in real-time based on the monitored parameters. After the rules are generated in real time, the rules are applied to data traffic being handled by adaptive traffic manager 130.

To optimize web and video traffic, traffic management techniques can be implemented on a proxy device (e.g., adaptive traffic manager 130) that is located somewhere between a content server and client devices (e.g., mobile terminals). The proxy device can determine the type of content requested by a mobile terminal (e.g., video content) and apply optimization techniques. The content providers can transmit content using unsecured or secured communication protocols such as Hypertext Transfer Protocol Secure (HTTPS), Transport Layer Security (TLS), and Secure Sockets Layer (SSL) protocols. As is further described in detail below, the proxy device can determine the type of content being transmitted in both unsecured and secured sessions based on, for example, identification information of the server (e.g., one of servers 160A-F), using client requests and server responses. In a secured session, the client requests and server responses are encrypted, and therefore may not be decipherable by the proxy device.

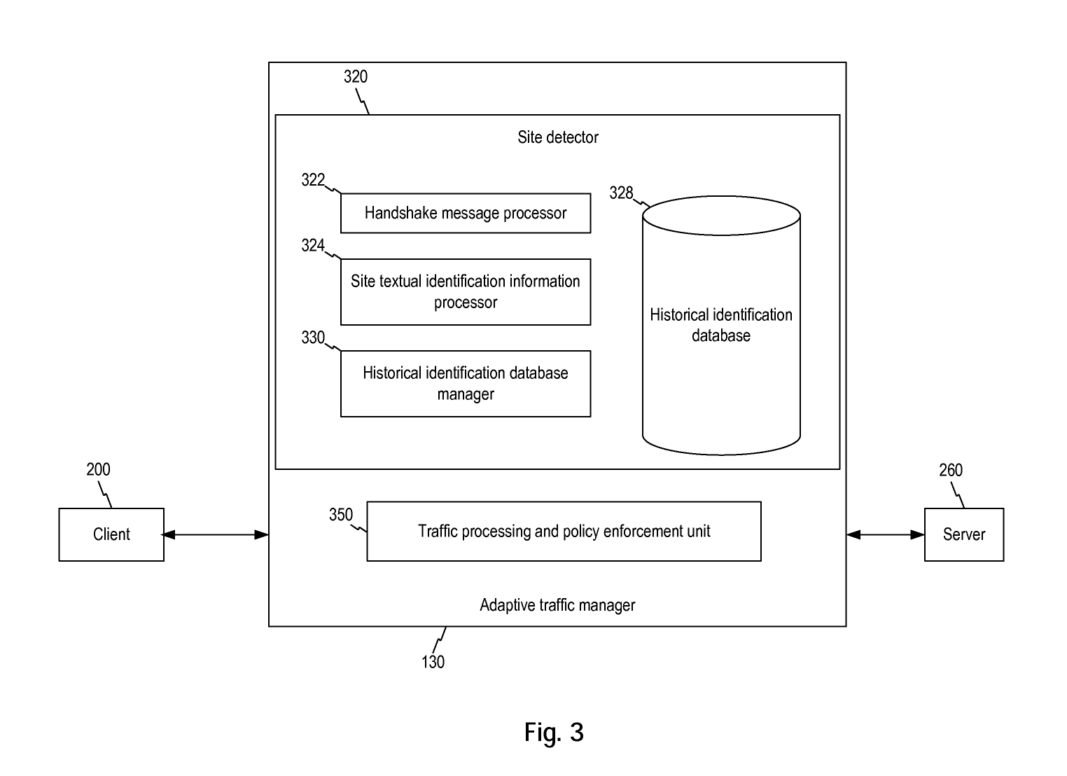

Adaptive traffic manager 130 can include a site detector (e.g., site detector 320 as shown in FIG. 3) to determine site textual identification information of a server, which hosts a site and generates traffic. The site textual identification information can include the domain name of the server and the name of the organization that operates the server. Such site textual identification information can be useful for traffic management. For example, keywords can be identified from the site textual identification information to determine the service provided by the server. The keywords (or the service provided by the server) can also indicate the type of content data being provided by the server.

As an example, the name of the organization that operates the server can be associated with a particular type of content traffic (e.g., YouTube™ is associated with video data). In a case where an organization serves different types of content over the network, the domain name can be used to classify the type of content provided by that organization. For example, both domain names “scholar.google.com” and “video.google.com” are operated by Google, Inc. But “scholar.google.com” is typically associated with data for transmission of documents, while “video.google.com” is typically associated with data for transmission of videos. Therefore, the content type (e.g., documents or videos) can be determined according to the organization name and/or the domain name. Using such determination, the traffic optimization techniques can be applied in a more customized manner.

Moreover, such content type information can also be useful for analytics purposes. For example, the content type information allows a breakdown of network traffic data across entities and across the domains that these entities operate. As a result, the granularity of the analysis can be more refined, and the application of the optimization techniques can become more refined as well.

The identity of the server may not be decipherable to intermediate network nodes (e.g., a proxy device) in secured traffic. In some cases, the site textual identification information associated with a server (e.g., the domain name and the organization name) can be determined based on handshake messages exchanged during the establishing of a Secure Sockets Layer (SSL)/Transport Layer Security (TLS) session.

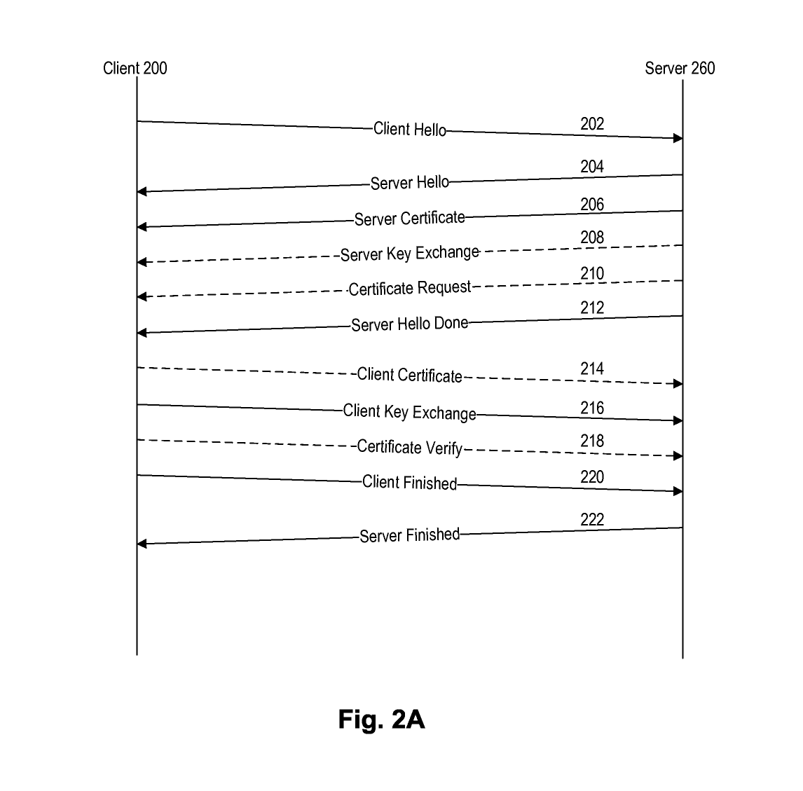

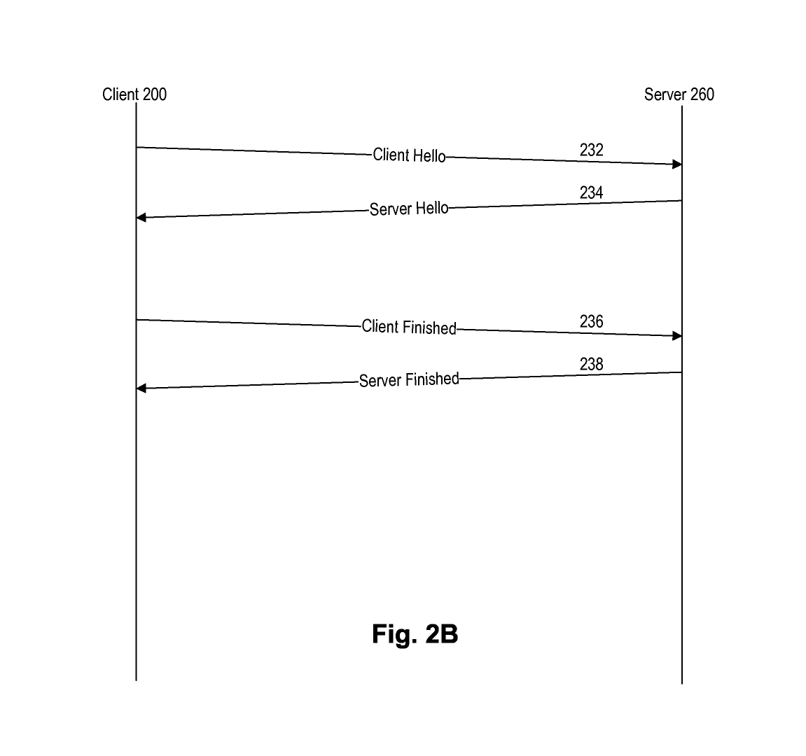

FIG. 2A illustrates an exemplary message flows between client device 200 and server 260, for establishing a SSL/TLS session. As shown in FIG. 2A, to establish a SSL/TLS session, client device 200 can send a client hello message 202 when client device 200 first connects to server 260. Client device 200 can also send client hello message 202 in response to a hello request (not shown) or on its own initiative to renegotiate the security parameters in an existing connection. Client hello message 202 can include, among other things, a session identification (ID) field, and a server name indication (SNI) field. In some embodiments, the SNI field provides a textual identification of the destination host requested by client device 200. The SNI field can be used as a site textual identifier to determine identification information (e.g., domain name) about server 260. Session ID can be used to identify the session and can be used for resuming a previously-established session. Session ID and resuming a previously-established session are described in more detail below.

After server 260 receives client hello message 202, it can respond with a server hello message 204. Server hello message 204 can also include, among other things, a session ID corresponding to the session.

Server 260 can also send a server certificate message 206 to client device 200. In some embodiments, server 260 sends server certificate message 206 if the agreed-upon key exchange method uses certificates for authentication. Server certificate message 206 can include one or more certificates, which can have certificate's public key. The certificate's public key can include a subject field identifying the organization (e.g., Google) associated with the public key stored in the subject public key field. The certificate also includes a subject-alt-name (SAN) field, which can include a list of host/domain names protected under the certificate. In some embodiments, the SAN field can be empty.

Server certificate message 206 also includes a common name field. A common name can be composed of host and domain names (e.g., www.youtube.com). In some cases, the common name can be the same as or similar to the web address that client device 200 requests to access when establishing a secured connection. In some cases, the common name can be identical to one of the domain names included in the SAN field. Server certificate message 206 also includes an organization field. The value associated with the organization field can represent an organization name used as the legal or business name of an organization that owns the certificate, or a subsidiary or business unit underneath the organization. Similar to SAN field, in some instances the organization field can be empty. The SAN field and the common name field, and the organization field can be used as site textual identifiers to determine site textual identification information associated with a server, such as a domain name and an organization name.

As shown in FIG. 2A, after server 260 sends server certificate message 206, client device 200 and server 260 exchange other messages, including server key exchange message 208, certificate request message 210, server hello done message 212, client certificate message 214, client key exchange message 216, and certificate verify message 218. After the client and server exchange client finished message 220 and server finished message 222, the handshake ends.

In some embodiments, after receiving client finished message 220, server 260 also sends a NewSessionTicket message (not shown) to client device 200, and the NewSessionTicket message can include a session ticket field. A session ticket includes state information that is generated by server 260 when the session is first established. Server 260 does not store the state information when the session ends. Server 260 can transmit the state information that is included in the session ticket field as part of the NewSessionTicket to client device 200. For resuming the previously-established session, client device 200 can send the session ticket data back to server 260. The session ticket data can be included in the session ticket extension of client hello message 202. The session ticket can also be used to identify a particular SSL/TLS session, and can be used for resuming a previously-established session, as described in more detail below.

FIG. 2B illustrates another exemplary message flows between a client device 200 and a server 260, for resuming a previously-established SSL/TLS session. As shown in FIG. 2B, to resume a SSL/TLS session, client device 200 can send a client hello message 232, which can include the session ID that is generated when the session is first established. The session ID allows server 260 to retrieve state information associated with the previously-established session that is stored at server 260. Server 260 can then use the state information to resume the previously established session. In some embodiments, server 260 does not store the state information. Client device 200 can thus transmit the state information, which it previously received from server 260 through the NewSessionTicket message, back to server 260 to resume the session. The state information can be transmitted as part of a session ticket extension of client hello message 232. After server 260 receives client hello message 232, it can respond with a server hello message 234, which can be similar to server hello message 204 of FIG. 2A and its description is not repeated here. After the exchange of the hello messages, client device 200 and server 260 can send, respectively, client finished message 236 and server finished message 238, to indicate the end of a handshake.

As discussed before, the SNI field is included in the client hello message; the organization name field, the common name field, and the SAN field are included in the server certificate message. The SNI field, the organization name field, the common name field, and the SAN field can include site textual identification information (e.g., organization name and domain name) associated with server 260. In some embodiments, SNI field is not present. Moreover, for resuming a previously-established SSL/TLS session, an abbreviated handshake between the client and server can occur. In an abbreviated handshake, server 260 does not send server certificate message. Therefore, the information included in the server certificate message, such as the organization name field, the common name field, and the SAN field, is not available when the session is resumed. In such a case, the site textual identification information may not be readily available from the handshake messages.

In some embodiments, the site textual identification information of server 260 can be determined from a resumed SSL/TLS session by acquiring site textual identification information obtained at an earlier time (e.g., when that session was established and server certificate message was transmitted). For example, a database (e.g., historical identification database 328 as shown in FIG. 3) can be used to organize previously-obtained site textual identification information when a session was established. Moreover, in the database, the previously-obtained site textual identification information can be associated with parameters that are used for resuming a session. When the session is resumed, these parameters can be used to query the database for accessing the previously-obtained site textual identification information.

As an example, these parameters can include session identification parameters (e.g., session ID or session ticket) that are included in the client hello messages or server hello messages, and a server IP address that is sent as part of the communication protocol (e.g., Internet Protocol (IP)). For example, the server IP address can be a destination address as part of an IP header. As described before, in both cases of establishing and resuming a session, hello messages can be exchanged between client device 200 and server 260. The hello messages can include at least one of the session ID or the session ticket (e.g., a session ticket provided in a client hello message). Moreover, a server IP address can also be present. These parameters can then be associated with previously-obtained site textual identification information in the database. As will be described later, these parameters can be used to search for the previously-obtained site textual identification information in a database that stores the information.

In some embodiments, where tunneling proxies are used, client device 200 can establish a Transmission Control Protocol (TCP) connection with a proxy server (not shown) and send a HTTP CONNECT request indicating the final destination server (e.g., server 260). In this case, the domain name can also be determined based on the Universal Resource locator (URL) and/or other headers in the HTTP CONNECT request.

FIG. 3 is a block diagram illustrating an embodiment of an exemplary adaptive traffic manager 130 for determining site textual identification information. In some embodiments, as shown in FIG. 3, adaptive traffic manager 130 can include a site detector 320 and a traffic processing and policy enforcement unit 350. Site detector 320 can be integrated with adaptive traffic manager 130. Adaptive traffic manager 130 can have one or more processors and at least one memory for storing program instructions. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as random access memory (RAM), read-only memory (ROM), volatile memory, nonvolatile memory, a flexible disk, a hard disk, a CD-ROM (compact disk-read only memory), and MO (magneto-optical), a DVD-ROM (digital versatile disk-read only memory), a DVD RAM (digital versatile disk-random access memory), flash drives, magnetic strip storage, semiconductor storage, optical disc storage, magneto-optical disc storage, flash memory, registers, caches, and/or any other storage medium. Singular terms, such as “memory” and “computer-readable storage medium,” can additionally refer to multiple structures, such as a plurality of memories and/or computer-readable storage mediums. Alternatively, the methods can be implemented in hardware components or combinations of hardware and software such as, for example, ASICs or one or more computers.

In some embodiments, site detector 320 can be integrated into other existing network elements such as gateway 120, controllers 104, and/or one or more base stations 106-109 of FIG. 1. Site detector 320 can also be a standalone network element located at gateway 120, controller 104, one or more base stations 106-109, or any other proper locations.

As shown in FIG. 3, adaptive traffic manager 130 can also include a traffic processing and policy enforcement unit (TPPE) 350, which is a lower stack in the processing stack of adaptive traffic manager 130. TPPE unit 350 is responsible for routing traffic between client device 200 and server 260, and can acquire one or more handshake messages associated with establishing or resuming a secure session (e.g., SSL/TLS) between client device 200 and server 260. TPPE unit 350 can be a software program and/or a hardware device.

As shown in FIG. 3, site detector 320 can include, among other things, a handshake message processor 322, a site textual identification information processor 324, and a historical identification database 328, which can be managed by historical identification database manager 330. In some embodiments (not shown in FIG. 3), historical identification database 328 can be a separate entity from site detector 320 (or adaptive traffic manager 130). Historical identification database 328 can be external to adaptive traffic manager 130. In some embodiments, historical identification database 328 can be implemented using a distributed storage mechanism, where local copies can be stored at one or more nodes (e.g., serving node 105A of FIG. 1), and the data can be periodically synchronized across the nodes.

Referring to FIG. 3, handshake message processor 322 can process (e.g., parse) the handshake messages acquired by TPPE 350, and obtain parameters from the fields included in these messages. The handshake messages exchanged between client device 200 and server 260 can be used for establishing or resuming a secured session (e.g., a SSL/TLS session) between client device 200 and server 260. The parameters obtained based on the handshake messages can include, for example, parameters associated with the SNI field, the session ID field (or the session ticket field) from the client/server hello messages, the session ticket field of the NewSessionTicket message sent by server, the SAN field, the common name field, and the organization name field from the server certificate message.

Site textual identification information processor 324 can determine site textual identification information, such as domain name and organization name, based on the parameters collected by handshake message processor 322. Based on the parameters available from handshake message processor 322, site textual identification information processor 324 can determine whether the handshake messages include site textual identifiers (e.g., the SNI field of client hello messages, the SAN field, the common name field, and the organization field from the server certificate message). If site textual identification information processor 324 determines that the handshake messages include site textual identifiers, site textual identification information processor 324 can determine the site textual identification based on the site textual identifiers included in the handshake messages. If site textual identification information processor 324 determines that the handshake messages does not include site textual identifiers, site textual identification information processor 324 can query historical identification database 328, which stores previously-determined site textual identification information. In some embodiments, if the site textual identification information is determined based on the site textual identifiers included in the handshake messages, historical identification database 328 can also be queried to determine whether the database needs to be updated with the newly-determined site textual identification information. After such query historical identification database 328 can be updated as needed. Exemplary methods of deducing site textual identification information and updating the site textual identification information are described in more detail below.

As discussed before, historical identification database 328 stores previously-determined site textual identification information (including, for example, domain names and organization names). Thus, if the site textual identification information cannot be determined from the handshake messages, historical identification database 328 can be queried for the site textual identification information. In some embodiments, the previously-determined site textual identification information can be organized under a hierarchy tree structure to provide an estimated representation of a domain hierarchy operated by an organization. A response to the query can be provided according to a mapping between each of the elements of the hierarchy tree structure (including the child node and the root node) and parameters associated with a session (e.g., session identifier, IP address, etc.). Exemplary methods of organizing previously-determined site textual identification information are described in more details below.

As discussed before, historical identification database manager 330 manages historical identification database 328. In some embodiments, historical identification database manager 330 can maintain one or more mapping tables between parameters that are available in the handshake messages of a secured session (e.g., session identifiers including a session ID or a session ticket, and a server IP address) and previously-determined site textual identification information stored in historical identification database 328. Historical identification database manager 330 can also add newly-determined site textual identification information to historical identification database 328, and update the one or more mapping tables to reflect the addition. Exemplary methods of mapping between the parameters and previously-determined site textual identification information are descried in more detail below.

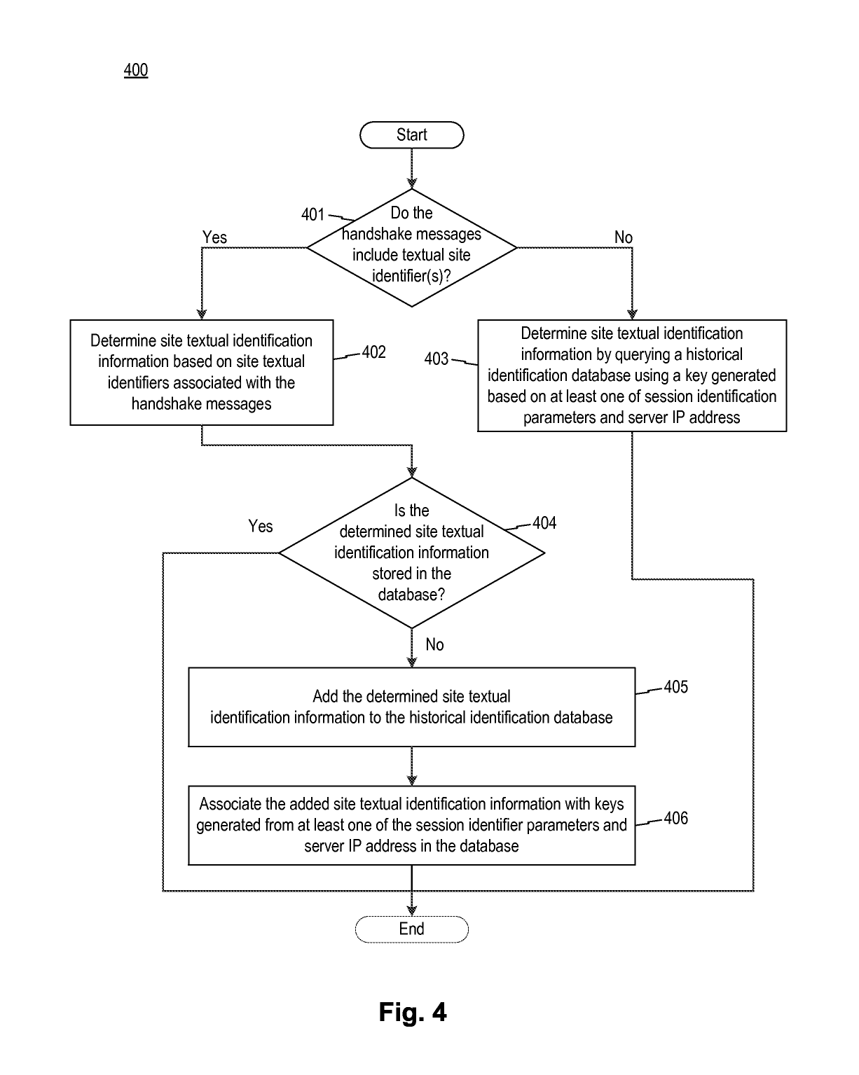

FIG. 4 is a flowchart representing an exemplary method 400 for determining the site textual identification information (e.g., domain name and/or organization name) of a server associated with a secured session. Referring to FIG. 4, it will be readily appreciated that the illustrated procedure can be altered to delete steps or further include additional steps. Method 400, as well as all other methods presented in the present disclosure, can be performed by an adaptive traffic manager (e.g., adaptive traffic manager 130), and more particularly by a site detector (e.g., site detector 320) of the adaptive traffic manager. While the methods are described as being performed by site detector 320, it is appreciated that other components of adaptive traffic manager or other devices can be involved.

After an initial step, site detector 320 can determine (step 401) whether the handshake messages include site textual identifiers by, for example, parsing the handshake messages. As stated above, site textual identifiers can include, for example, the SNI field of client hello messages, the SAN field, the common name field, and the organization field from the server certificate message. If the handshake messages include site textual identifiers, site detector 320 can determine (step 402) site textual identification information based on site textual identifiers associated with the handshake messages. If the handshake message does not include site textual identifiers, site detector 320 can determine (step 403) site textual identification information by querying historical identification database 328. The querying can be performed using a key generated based on at least one of session identification parameters (e.g., a session ID or a session ticket of a client hello message) and a server IP address. A response to the query can be made according to a mapping between the key and stored information (e.g. an organization name, and/or a domain name) of historical identification database 328.

In the case where the site textual identification information is determined (step 402) based on site textual identifiers, site detector 320 can query the historical identification database 328 to determine (step 404) whether the newly-determined site textual identification information is stored in the database. If the newly-determined information is not stored in the database, site detector 320 can store (step 405) the newly-determined information to historical identification database 328. The newly-determined information can be stored, for example, using a tree structure, which is described in more detail below. Site detector 320 can also associate the added information with keys generated from at least one of the session identification parameters and server IP address in the database, in step 406. After step 406, method 400 can proceed to an end.

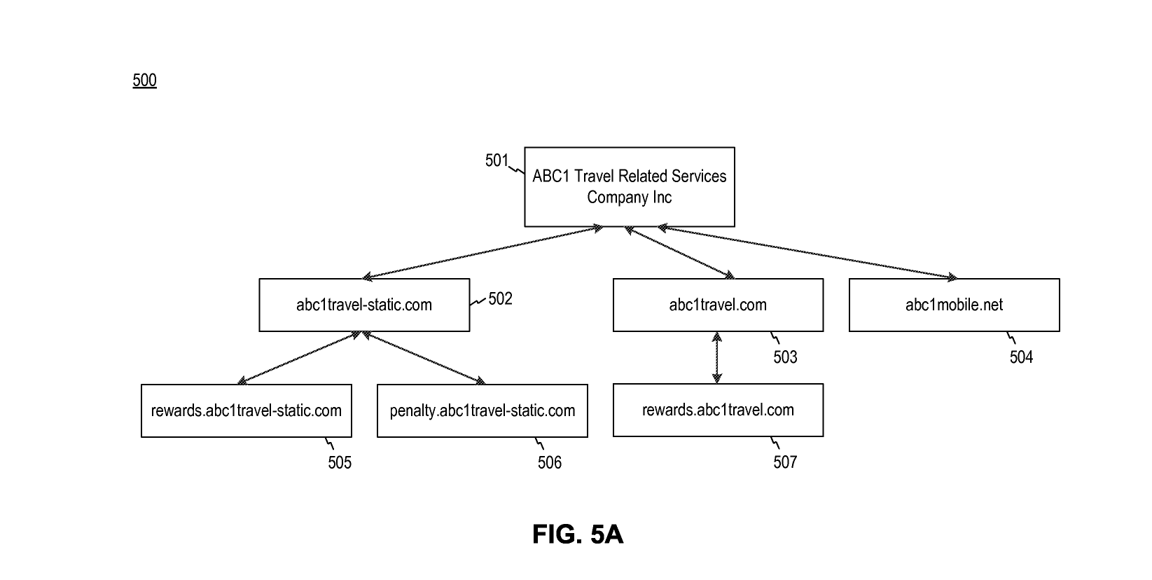

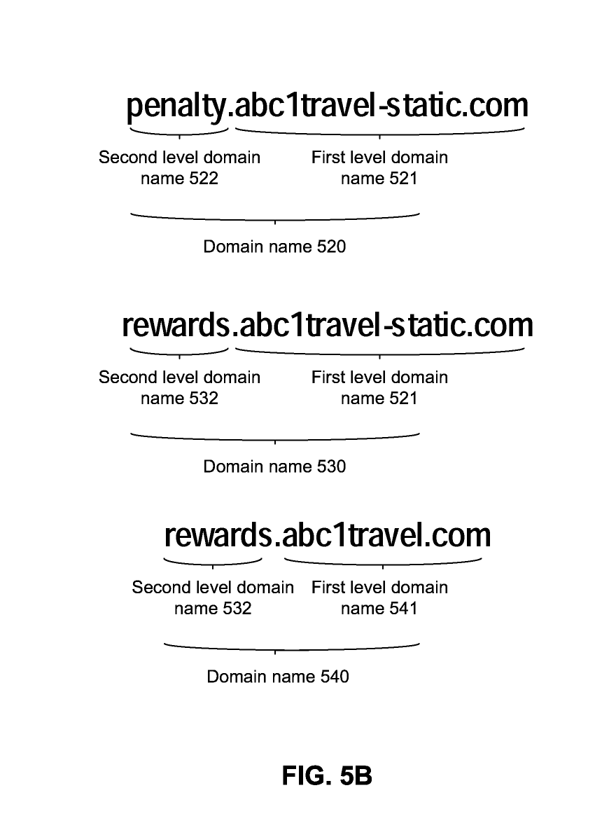

FIG. 5A is a diagram illustrating an exemplary hierarchy tree 500 for organizing previously-determined site textual identification information. As an illustrative example, the previously-determined site textual identification information of FIG. 5A includes previously-determined domain names and organization names associated with servers 160(A-F) of FIG. 1. In some embodiments, as shown in FIG. 5A, the syntax of the domain names organized under hierarchy tree 500, and the structure of the hierarchy of domain names, can be consistent with the definitions under the Domain Name System (DNS). Hierarchy tree 500 includes a root node 501, and one or more child nodes 502-507. In some embodiments, hierarchy tree 500 can be constructed based on previously-determined site textual identification information to provide an estimated domain structure operated by an organization.

As shown in FIG. 5A, root node 501 is associated with a string “ABC1 Travel Related Services Company Inc,” which represents an organization name. In some embodiments, an organization name refers to a legal name or a business name of the organization that owns the domain names listed in hierarchy tree 500.

In FIG. 5A, child nodes 502-507 are each associated a domain name. Under the DNS hierarchy, Top-Level Domain Names are the highest level of domain names, and can be categorized into two groups: generic domains such as “com,” “gov,” “org,” etc., and country code domain names such as “us,” “uk,” and “au.” Top-Level Domain Names are not shown in FIG. 5A. The Second-Level Domain Names, as defined under the DNS hierarchy, are the domain names that are directly below the Top-Level Domain Names. The Third-Level Domain Names are those below the Second-Level, and the Fourth-Level is below the Third-Level, and so forth. As shown in FIG. 5A, the first level of child nodes (e.g., child nodes 502, 503, and 504) of hierarchy tree 500 are associated with Second-Level Domain Names, while the second level of child nodes (e.g., child nodes 505, 506, and 507) of hierarchy tree 500 are associated with Third-Level Domain Names.

In some embodiments, a domain can include a subdomain. A subdomain name is created from a parent domain name by adding a new level of domain name on the left of the parent domain name, separated by a dot. A domain and its subdomains can manifest an ancestor-successor relationship within hierarchy tree 500. For example, child node 505, which is associated with the domain name “rewards.abc1travel-static.com” is a successor to child node 502, which is associated with the domain name “abc1travel-static.com,” and “rewards.abc1travel-static.com” is a subdomain of “abc1travel-static.com.” Child node 502 is also a parent node of child node 505, because child node 505 has only one extra level of domain name (“rewards”) compared with child node 502.

In some embodiments, a domain can also include multiple subdomains, and the domain becomes a common ancestor of the multiple subdomains. The determination of whether common ancestor relationship exists between two domain names can be performed by first comparing the first level of domain names (including the Top-Level Domain Name such as “.com”), starting from the right. If the first level of domain name is not identical between the two domain names, it can be determined that the two domain names do not have common ancestor. If the first level of domain names are the same, then the second level of domain names (on the left of the first level of domain name) are compared, and so on, until a difference is found at a certain level of domain name. The aggregate levels of domain names that are identical, up to before the level of domain names that are different, can be determined as the common ancestor. In some embodiments, a common ancestor has commonality more than just having identical Top-Level Domain Name. Moreover, in hierarchy tree 500, a common ancestor is a domain name starting from the Second-Level Domain Name (i.e., associated with first level child nodes) and cannot be a root node.

FIG. 5B provides an example for illustrate the determination of ancestor-successor relationship and common ancestor relationship. As shown in FIG. 5B, domain name 520 “penalty.abc1travel-static.com” has a first level domain name 521, starting from the right, as “abc1travel-static.com,” and a second level domain name 522 “penalty.” Domain name 530 “rewards.abc1travel-static.com” also has first level domain name 521, but with a different second level domain name 532 “rewards.” Domain name 540 “rewards.abc1travel.com” has a different first level domain name 541 compared with domain names 520 and 530, but it also has an identical second level domain name 532 as domain name 530.

In the example as shown in FIG. 5B, domain names 520 and 530 have commonality at the first level domain name “abc1travel-static.com,” and their common ancestor is the common first level domain name. Domain names 530 and 540 do not have a common ancestor, because they do not have identical first level domain name, despite the fact that they have common second level domain name. Accordingly, node 502, which is associated with domain name “abc1travel-static.com,” is also a common ancestor of child nodes 505 and 506, which are associated, respectively, with domain names 520 and 530. Child node 507, which is associated with domain name 540, does not have a common ancestor with child nodes 505 and 506.

Referring back to FIG. 5A, in some embodiments, the domain names associated with child nodes 505, 506, and 507, which do not have successor child nodes, can be determined as a Fully Qualified Domain Name (FQDN). A FQDN can be a precise and unambiguous way to identify a server. However, sometimes FQDN cannot be determined based on the available information available in an encrypted session. For example, when the domain hierarchy is unknown, whether a child node has any successor node may not be readily determined. Instead, a domain name associated with a child node can be determined as the Most Specific Domain Name (MSDN). A MSDN can represent the result of the best effort to determine the most specific domain name, under the constraint of available information. In some embodiments, however, a string associated with a root node (e.g., root node 501) cannot be provided as a MSDN.

As an example, in FIG. 5A, hierarchy tree 500 can represent the actual domain tree structure operated by the company “ABC1 Travel Related Services Company Inc.” From the SSL/TLS handshake messages, there can be conflicting information about the domain name associated with the some of the servers 160(A-F). For example, different fields in the server certificate message transmitted in a session may provide different site textual identification information. As an example, the common name field may indicate that the traffic is generated from a host/domain name “rewards.abc1travel-static.com,” while the SAN field may indicate the traffic is generated from a host/domain name “penalty.abc1travel-static.com.” In this example, because there are conflicting indications about which site textual identification information should be used for the determined domain name (e.g., whether the SAN field should be used, or the common name field should be used), a common ancestor for both names (e.g., the “abc1travel-static.com” associated with child node 502) may be determined as the MSDN.

Given the information available, it can be determined that the most specific information that can be derived is that both “rewards.abc1travel-static.com” and “penalty.abc1travel-static.com” are the sub-domains of “abc1travel-static.com.” Therefore, determining that one of the servers 160(A-F) is associated with the domain name “abc1travel-static.com” can provide a site textual identification that is the most representative and specific for the server(s) involved in this particular session. However, the domain name determined in this situation is not a FQDN, at least because the child node 502 has other child nodes below it. In some embodiments, the domain names determined using the methods consistent with the present disclosure can be regarded as a MSDN. In a case where the domain name determined has no sub-domain names below it in the actual domain hierarchy tree, the determined domain name can be a FQDN.

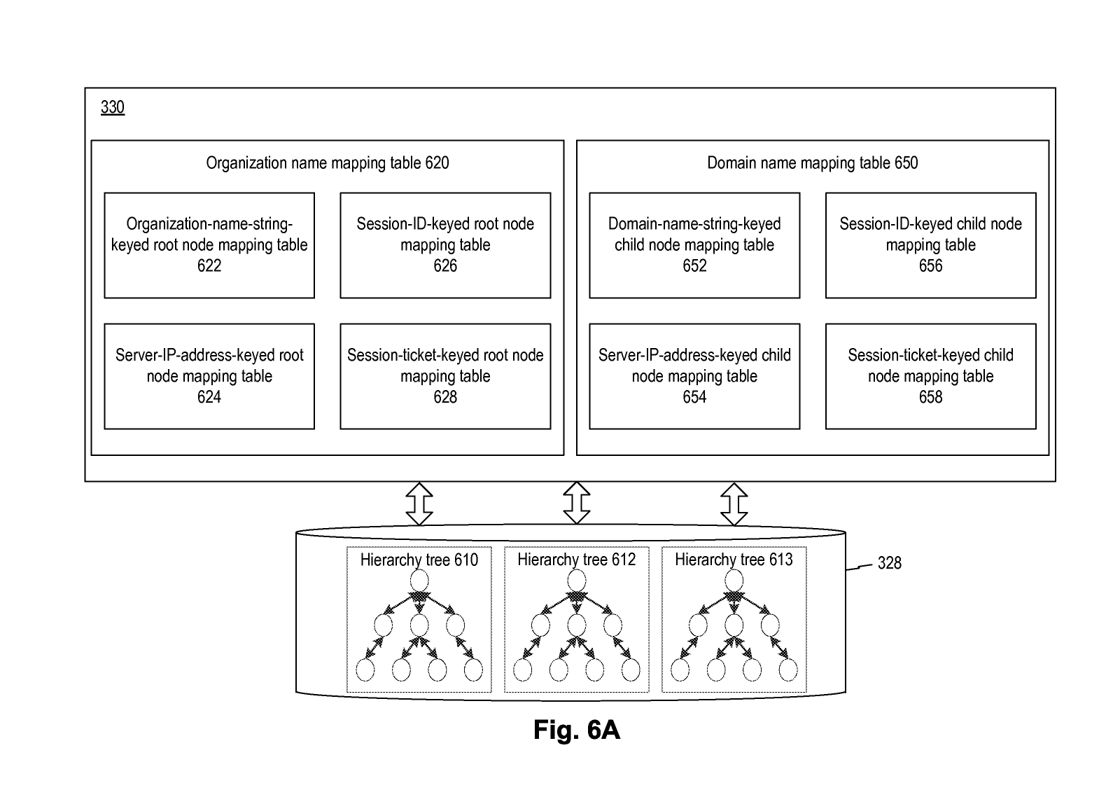

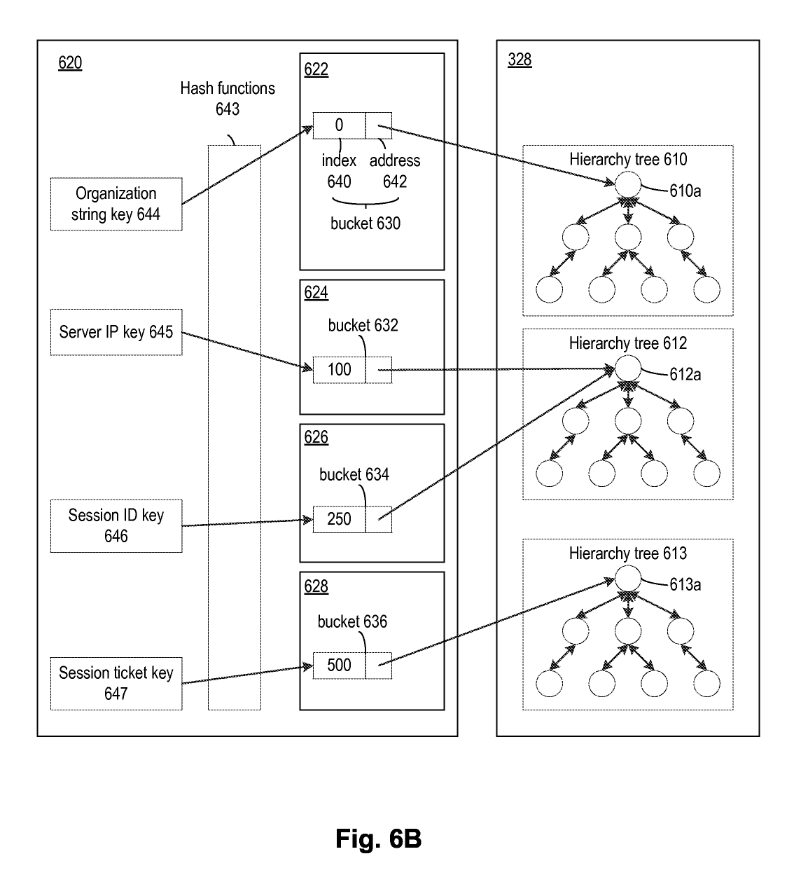

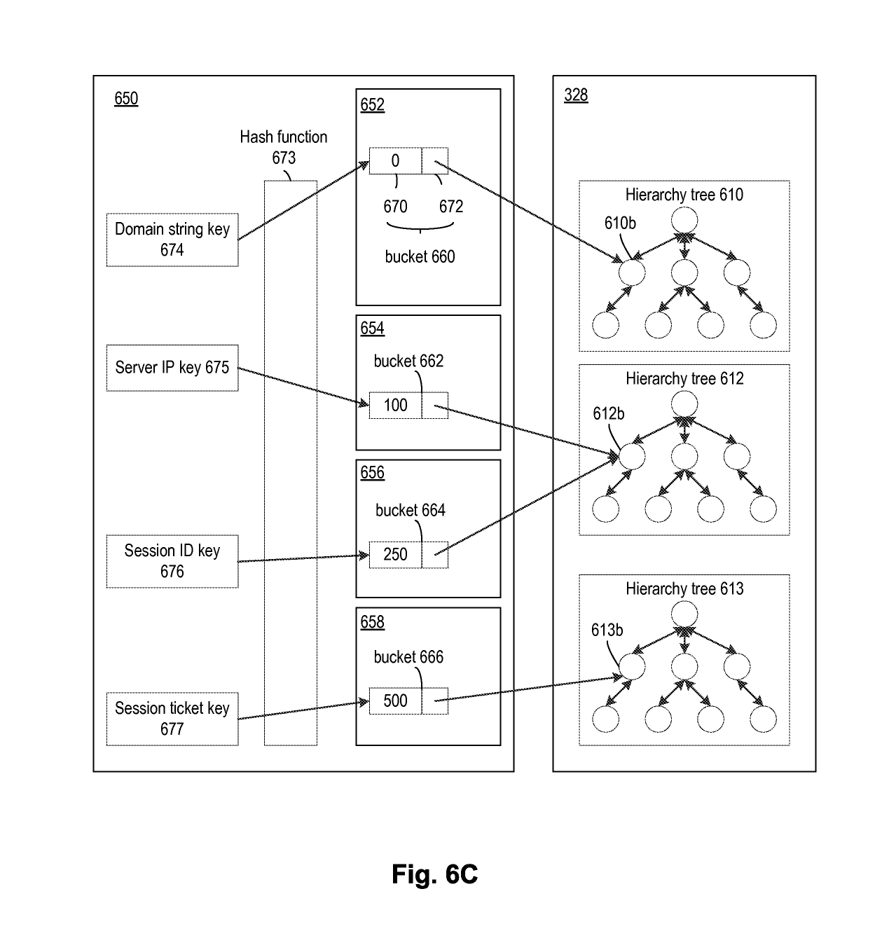

FIG. 6A is a block diagram illustrating an exemplary method of accessing and organizing previously-determined site textual identification information. As shown in FIG. 6A, the previously-determined organization names and domain names stored in historical identification database 328 can be organized under, for example, hierarchy trees 610, 612, and 613. Hierarchy trees 610, 612, and 613 can have the structure of hierarchy tree 500 (e.g., each tree includes a root node associated with an organization name, and child node(s) associated with domain name(s)). The hierarchy tree can be represented by any type of suitable data structure to allow linking between child nodes and root nodes (e.g., accessing the root node of a tree after locating one of the child nodes of the tree, and vice versa), and traversing of the tree nodes. A traversal of the tree nodes can be performed by, for example, accessing one or more nodes in the tree according to a pre-defined order.

In some embodiments, organization name mapping table 620 and domain name mapping table 650 can be used to provide access to the root nodes and child nodes, respectively, of hierarchy trees 610, 612, and 613. In some embodiments, historical identification database manager 330 of FIG. 3 maintains organization name mapping table 620 and domain name mapping table 650 and uses the tables to provide access to the root nodes and child nodes.

Organization name mapping table 620 includes an organization-name-string-keyed root node mapping table 622, a server-IP-address-keyed root node mapping table 624, a session-ID-keyed root node mapping table 626, and a session-ticket-keyed root node mapping table 628. Each of these mapping tables of organization name mapping table 620 can provide a mapping between a key, which can be generated by historical identification database manager 330, and an address associated with a root node in historical identification database 328. For organization-name-string-keyed root node mapping table 622, the key can be generated from a string representing an organization name, which can be extracted from the organization field of server certificate message, as described earlier. For server-IP-address-keyed root node mapping table 624, the key can be generated from a server IP address. The server IP address can be acquired from the same secured session based on which the organization name is extracted. For session-ID-keyed root node mapping table 626, the key can be generated from the session ID included in client/server hello messages acquired from the same session based on which the organization name is extracted. For session-ticket-keyed root node mapping table 628, the key can be generated from the session ticket from NewSessionTicket message sent by a server in the same session based on which the organization name is extracted.

As such, different keys can be mapped to an address of a root node. Because a root node can be accessed with different keys generated from different sources, a root node (and the organization name associated with) can be accessed in a later session if a particular source of information is not available in that session. For example, as described earlier, when a previously-established session is resumed, no server certificate message is transmitted. Therefore, the organization field included in the server certificate message is not available. But the organization name associated with the previously-established session, which is now being resumed, can still be retrieved using a key generated based on the session ID, the session ticket, or the server IP address, because at least one of the session ID, the session ticket, or the server IP address can be available in a resumed session.

Domain name mapping table 650 includes a domain-name-string-keyed child node mapping table 652, a server-IP-address-keyed child node mapping table 654, a session-ID-keyed child node mapping table 656, and a session-ticket-keyed child node mapping table 658. Each mapping table under 650 can provide a mapping between a key and an address associated with a child node in historical identification database 328. For domain-name-string-keyed child node mapping table 652, the key can be generated based on a string representing a domain name, which can be extracted from the client/server hello messages or the common name field and SAN field of server certificate message, as described earlier. For server-IP-address-keyed child node mapping table 654, the key can be generated from the server IP address. The server IP address can be acquired from the same secured session based on which the domain name is extracted. For session-ID-keyed child node mapping table 656, the key can be generated from the session ID included in client/server hello messages acquired from the same session based on which the domain name is extracted. For session-ticket-keyed child node mapping table 658, the key can be generated from the session ticket from NewSessionTicket message sent by a server in the same session based on which the domain name is extracted.

Similar to a root node, since a child node can be accessed by different keys generated from different sources, a child node (and the domain name associated with) can be accessed in a later session if a particular source of information is not available in that session. For example, in a case where SNI field is empty or where no server certificate is transmitted, and no site textual identifier is available, a child node can still be accessed using other available information such as the session identifiers and the server IP address.

FIG. 6B illustrates an exemplary structure of organization name mapping table 620 of FIG. 6A. As shown in FIG. 6B, each of organization-name-string-keyed root node mapping table 622, server-IP-address-keyed root node mapping table 624, session-ID-keyed root node mapping table 626, and session-ticket-keyed root node mapping table 628, can include one or more buckets (e.g., buckets 630, 632, 634, and 636). Each bucket includes a mapping between an index (e.g., index 640) and an address (e.g., address 642). As shown in FIG. 6B, each address refers to a location, in historical identification database 328, associated with a root node. An address can be a pointer. For example, bucket 630 includes an address associated with root node 610a, while bucket 636 includes an address associated with root node 613a. Multiple buckets can include an address associated with the same root node. For example, both buckets 632 and 634 can include an address associated with root node 612a.

In FIG. 6B, the indices can be generated using hash functions 643 based on a key. As illustrated in FIG. 6B, an organization string key 644, a server IP key 645, a session ID key 646, and a session ticket key 647 can each be mapped, using one of the hash functions 643, to buckets 630, 632, 634, and 636 respectively, and then to one of root nodes 610a, 612a, and 613a. As discussed before, buckets 632 and 634 both include an address associated with root node 612a. Therefore, server IP key 645 and session ID key 646 are both mapped to root node 612a. As a result, root node 612a, and the organization name associated with it, can be accessed using at least one of server IP key 645 and session ID key 646.

FIG. 6C illustrates an exemplary structure of domain name mapping table 650 of FIG. 6A. As shown in FIG. 6C, each of domain-name-string-keyed child node mapping table 652, server-IP-address-keyed child node mapping table 654, session-ID-keyed child node mapping table 656, and session-ticket-keyed child node mapping table 658 includes one or more buckets (e.g., buckets 660, 662, 664, and 666). Similar to organization name mapping table 620 of FIG. 6B, each bucket includes a mapping between an index (e.g., index 670) and an address (e.g., 672). As shown in FIG. 6C, each address refers to a location, in historical identification database 328, associated with a child node. For example, bucket 660 includes an address associated with child node 610b, while bucket 666 includes an address associated with child node 613b. Multiple buckets can be mapped to the same child node. For example, both buckets 662 and 664 can include an address associated with child node 612b.

The index can be generated, using hash functions 673, based on a key. As illustrated in FIG. 6C, a domain string key 674, a server IP key 675, a session ID key 676, and a session ticket key 677 can each be mapped, using one of hash functions 673, to buckets 660, 662, 664, and 666, respectively, and then to one of child nodes 610b, 612b, and 613b. As discussed before, both buckets 662 and 664 include an address associated with child node 612b. Therefore, server IP key 675 and session ID key 676 can both be mapped to child node 612b. As a result, child node 612b, and the domain name associated with it, can be accessed using either server IP key 675 and session ID key 676.

In some embodiments, site detector 320 can also avoid building multiple hierarchy trees for the same organization as a result of determining different organization names from the organization fields in the server certificate messages. For example, there can be minor differences in the organization fields in the server certificates associated with the same organization, when these server certificate messages are associated with different services the organization provides to their customers. If hierarchy trees are built based on the organization names determined from the server certificate messages, multiple similar hierarchy trees may result. In some embodiments, site detector 320 can detect, for example, that a pool of IP addresses are used as keys across two hierarchy trees, or that there is a similarity between the child nodes between hierarchy trees, etc. Based on such detection, site detector 320 can then determine to merge the trees into a single tree.

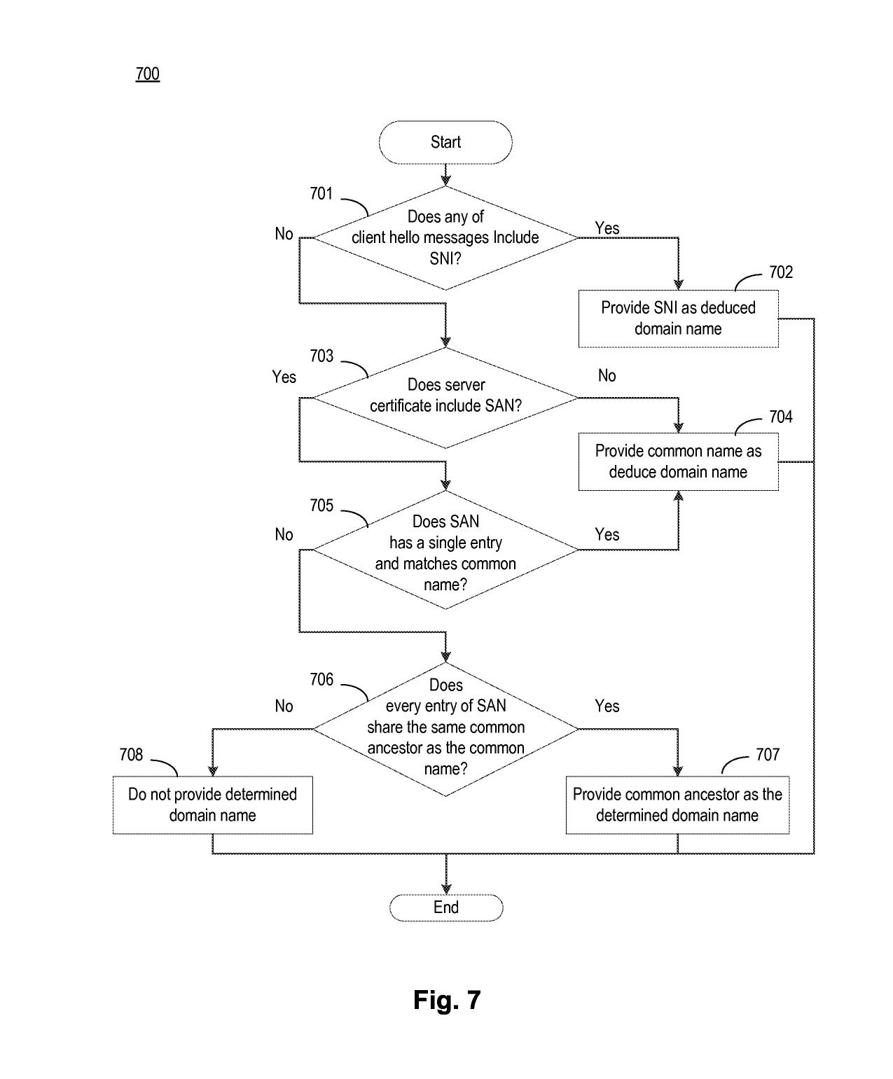

FIG. 7 illustrates an exemplary method 700 for determining domain name information from handshake messages associated with establishing a SSL/TLS session. The establishing of a SSL/TLS session can be enabled by, for example, the exchange of handshake messages as described in FIG. 2A. As discussed above, for establishing a SSL/TLS session, both client/server hello messages and server certificate messages can be transmitted. The domain name can be determined based on the SNI field of the client/server hello messages, and the SAN field and the common name field of the server certificate message, when these fields have values. Method 700 can be performed to determine the domain name information based on, for example, the availability of these fields, and the values associated with these fields. Referring to FIG. 7, it will be readily appreciated that the illustrated procedure can be altered to delete steps or further include additional steps. Method 700 can be performed by an adaptive traffic manager (e.g., adaptive traffic manager 130), and more particularly by a site detector (e.g., site detector 320) of the adaptive traffic manager. While the methods are described as being performed by site detector 320, it is appreciated that other components of adaptive traffic manager or other devices can be involved.

After an initial step, in step 701, site detector 320 determines whether any of the client hello messages associated with the session includes an SNI field. If site detector 320 determines that the client hello messages associated with the session includes the SNI field, site detector 320 can provide the value associated with the SNI field as the determined domain name, in step 702. As described before, the SNI field can provide a textual identification of the destination host requested by client device 200, therefore it can be used as a site textual identification for server 260, or the site which acts as the destination host.

If the SNI field is not available in any of the client hello messages, site detector 320 determines (step 703) whether the server certificate message includes the SAN fields. As described before, the SAN field can include a list of host/domain names associated with the server certificate. If the SAN field is empty or not included, the value associated with the common name field can be provided as the determined domain name, in step 704. As discussed before, the common name is typically composed of a host and domain name, and can be the same as or similar to the web address that client device 200 requests to access when establishing a secured connection. Therefore, the common name field can also provide a textual identification of the server 260 or the site. If the SAN field is not empty, site detector 320 can determine whether the SAN contains only a single entry of a host/domain name, and whether that entry matches with the common name, in step 705. If that is the case, the value associated with the common name field can also be provided as the determined domain name, as described in step 704.

If the single entry of the SAN field is different from the common name, or the SAN field has multiple entries, site detector 320 will determine whether the common name and all entries of the SAN field share a common ancestor domain name as described with respect to FIGS. 5A-B (in step 706). As describe before in FIGS. 5A-B, a common ancestor domain name (or the availability of it) can be determined by comparing between two multiple-level domain names. If such a common ancestor can be found, site detector 320 can provide the domain name of the common ancestor as the determined domain name, in step 707. As discussed before with respect to FIGS. 5A-B, in a case where there are conflicting indications about what domain names should be chosen from for the determined domain name (e.g., SAN field and the common name field indicating different domain names), finding a common ancestor between them represents the best effort to resolve the conflict and to provide a site textual identification for the servers involved in the session. On the other hand, if such a common ancestor cannot be found, site detector 320 provides no domain name, in step 708. After steps 702, 704, 707, or 708, method 700 can proceed to a stop.

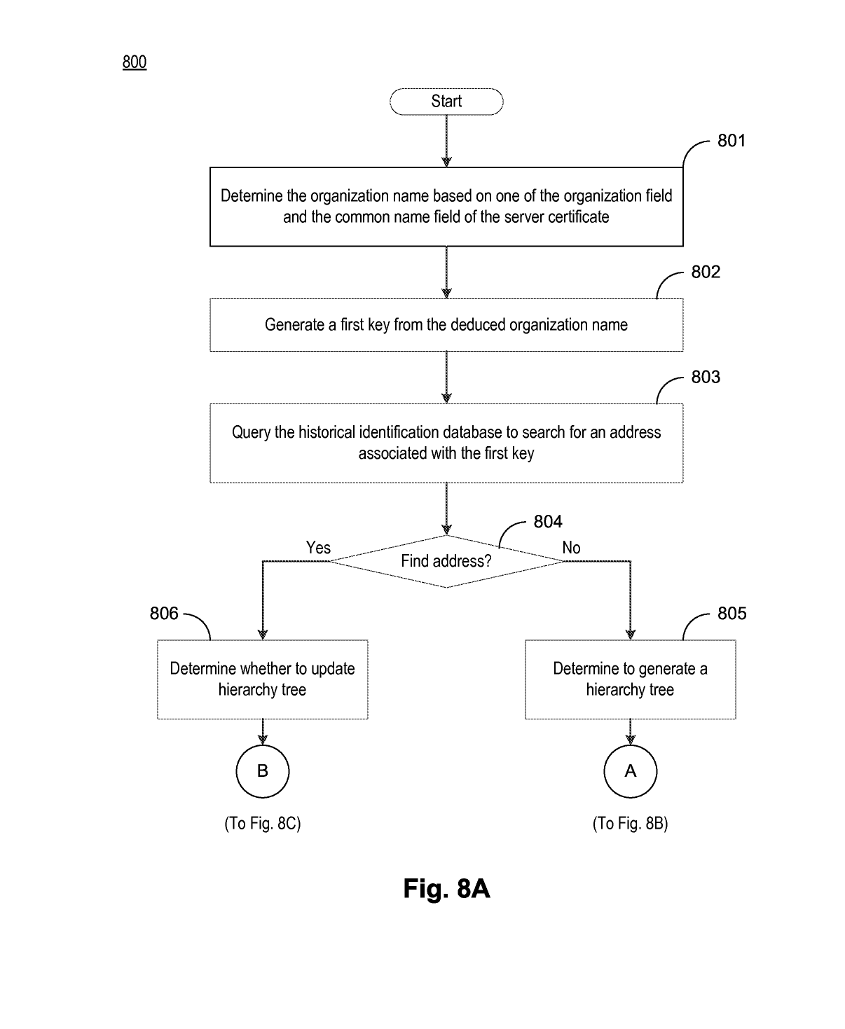

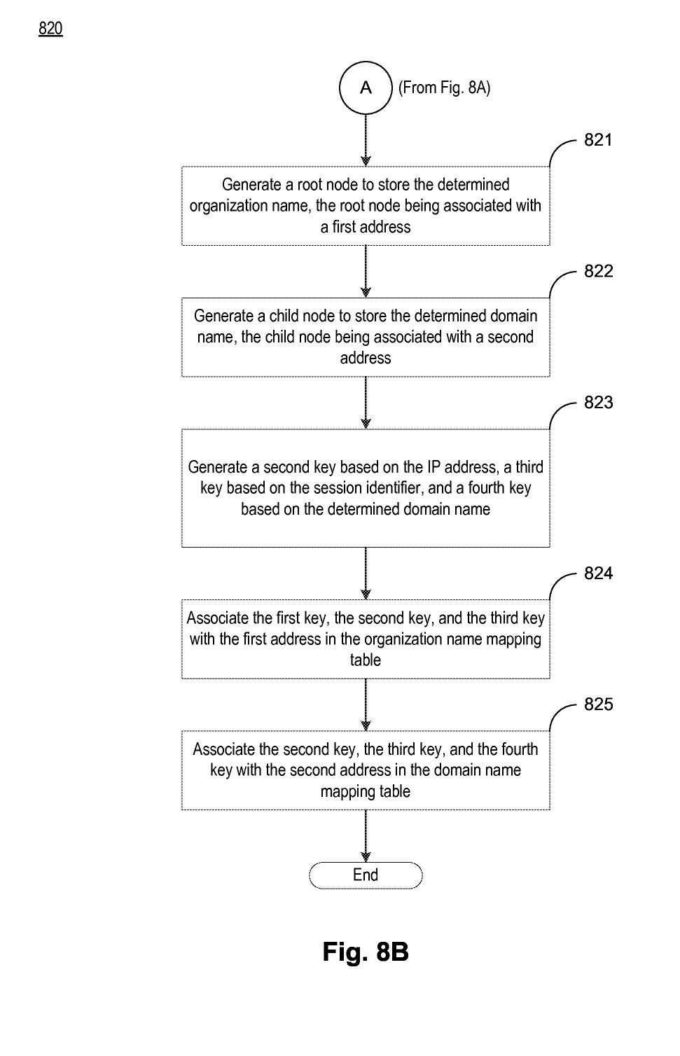

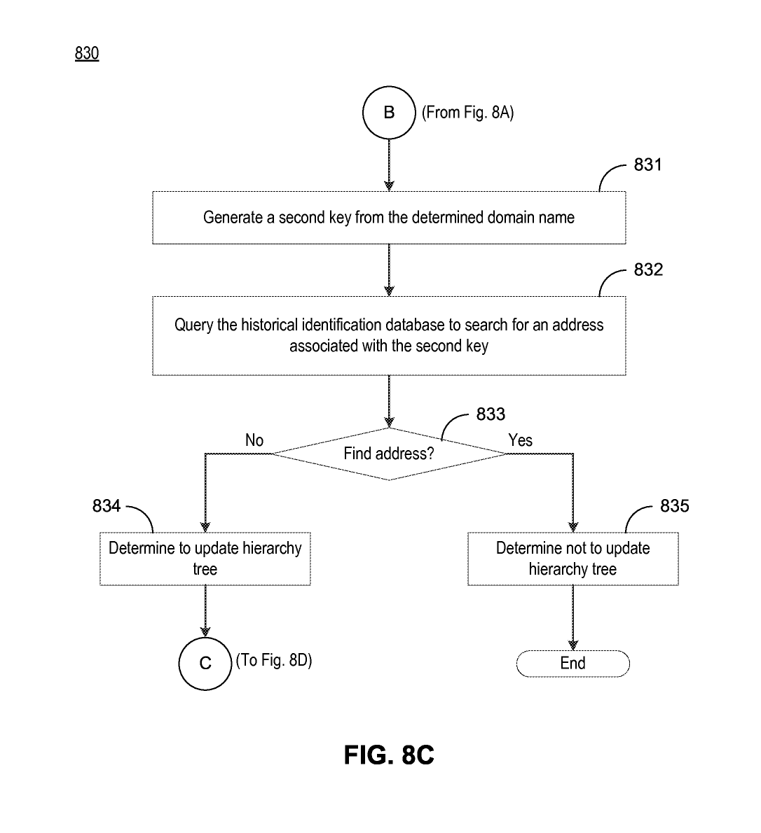

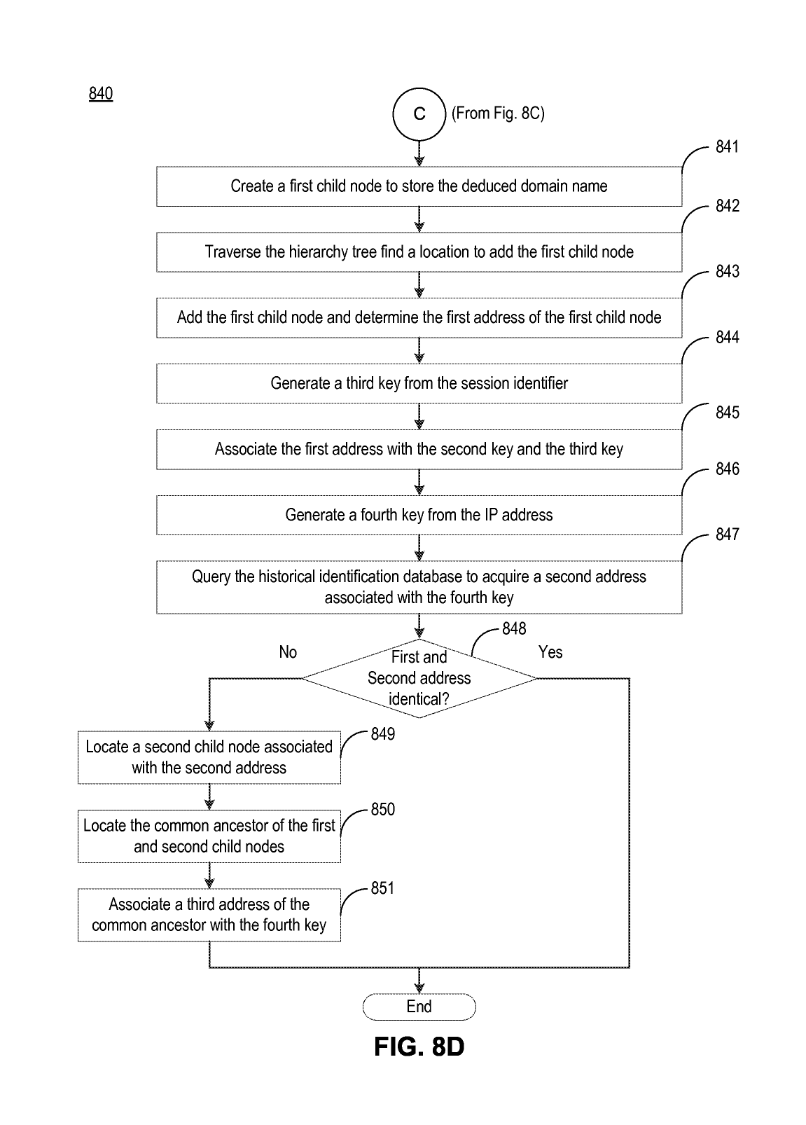

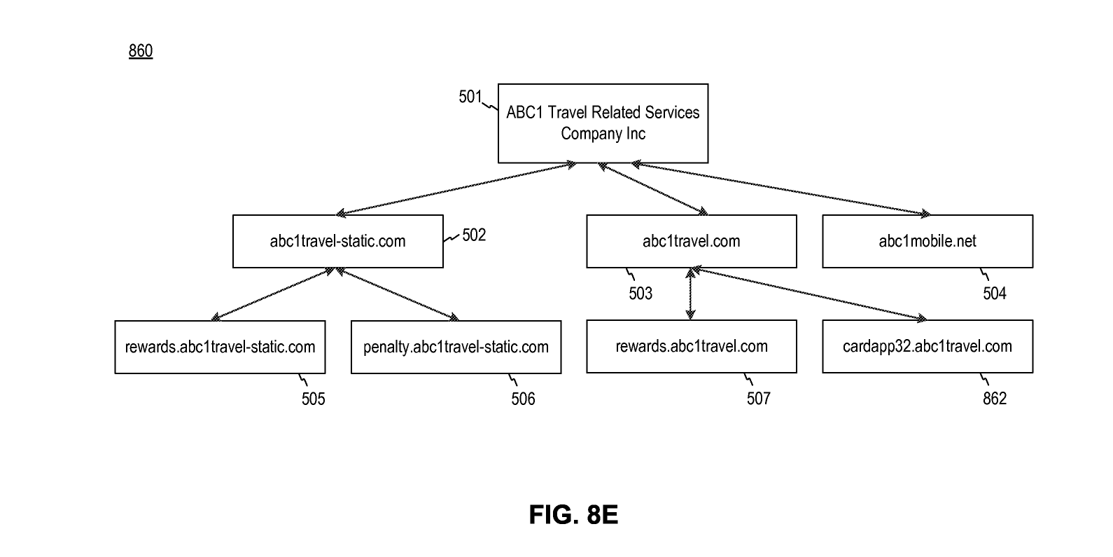

If a domain name can be determined from the handshake messages, site detector 320 can then determine whether a new domain hierarchy tree needs to be generated to store the recently-determined domain name. If site detector 300 determines that the new domain hierarchy tree does not need to be generated, it can further determine whether an existing domain hierarchy needs to be updated with the recently-determined domain name. FIG. 8A illustrates an exemplary method 800 for determining whether a new hierarchy tree needs to be generated. Referring to FIG. 8A, it will be readily appreciated that the illustrated procedure can be altered to delete steps or further include additional steps. Method 800 can be performed by an adaptive traffic manager (e.g., adaptive traffic manager 130), and more particularly by a site detector (e.g., site detector 320) of the adaptive traffic manager. While the methods are described as being performed by site detector 320, it is appreciated that other components of adaptive traffic manager or other devices can be involved.

In step 801, site detector 320 determines the organization name using at least one of the organization field and the common name field based on the server certificate. If the organization field is available in the certificate, site detector 320 can provide the value associated with the organization field as the determined organization name. If the organization field is empty, site detector 320 can provide the common name as the determined organization name.

In step 802, site detector 320 generates a key using the determined organization name. Any suitable method can be used. For example, the string representing the determined organization name can be converted to one or more numbers under American Standard Code for Information Interchange (ASCII), and the one or more numbers can then be used to generate the key.

In step 803, site detector 320 uses the key to query historical identification database 328 to search for an address of a root node associated with the key. For example, referring back to FIG. 6B, site detector 320 can calculate an index from the key using one of the hash functions 643, and then access a bucket associated with the index, under organization-name-string-keyed root node mapping table 622. Site detector 320 can then determine (step 804) whether the bucket is associated with any address.

If no address is found, it can indicate that historical identification database 328 does not store a hierarchy tree for an organization associated with the determined organization name, site detector 320 can determine to generate a hierarchy tree in step 805. After step 805, site detector 320 will proceed to step 821 of FIG. 8B to generate the hierarchy tree, as to be described below. If the address is found, site detector 320 can determine whether to update the existing hierarchy tree, in step 806. The determination of whether to update a hierarchy tree will be described in FIG. 8C.

FIG. 8B illustrates an exemplary method 820 for generating a new hierarchy tree, and updating organization name mapping table 620 and domain name mapping table 650 correspondingly, after step 805 of FIG. 8A. Referring to FIG. 8B, it will be readily appreciated that the illustrated procedure can be altered to delete steps or further include additional steps. Method 820 can be performed by an adaptive traffic manager (e.g., adaptive traffic manager 130), and more particularly by a site detector (e.g., site detector 320) of the adaptive traffic manager. While the methods are described as being performed by site detector 320, it is appreciated that other components of adaptive traffic manager or other devices can be involved.

In step 821, site detector 320 can generate a root node to store the determined organization name. The root node can be associated with a first address after the generation of the root node.

In step 822, site detector 320 can generate a child node to store the determined domain name. The child node can be associated with a second address after the generation of the child node

In step 823, site detector 320 can generate a second key based on the server IP address, a third key based on the session identifier (e.g., either the session ID or the session ticket), and a fourth key based on the determined domain name, depending on the information available from the handshake messages. For example, the session ID or the session ticket can be available, but not both.

In step 824, site detector 320 can update organization name mapping table 620 by associating the first key (the key generated based on organization name in step 802 of FIG. 8A), the second key (the key generated based on the server IP address) and the third key (the key generated based on the session identifier) with the first address of the newly-generated root node. For example, referring back to FIG. 6B, site detector 320 can use hash functions 643 to calculate, for each key, an index. A bucket in organization-name-string-keyed root node mapping table 622 can be generated to store a mapping between the index generated from the first key and the first address. Similar actions can be performed for other tables under organization name mapping table 620 as well.

In step 825, site detector 320 can update domain name mapping table 650 by associating the second key (the key generated based on the server IP address), the third key (the key generated based on the session identifier), and the fourth key (the key generated based on the determined domain name) with the second address of the newly-generated child node. For example, referring back to FIG. 6C, site detector 320 can use hash functions 673 to calculate, for each key, an index. A bucket in domain-name-string-keyed child node mapping table 652 can be generated to store a mapping between the index generated from the fourth key and the second address. Similar actions can be performed for other tables under domain name mapping table 650 as well. Method 820 can proceed to a stop after step 825.

FIG. 8C illustrates an exemplary method 830 for determining whether to update an existing hierarchy tree, and for updating organization name mapping table 620 and domain name mapping table 650 correspondingly, after step 806 of FIG. 8A. Referring to FIG. 8C, it will be readily appreciated that the illustrated procedure can be altered to delete steps or further include additional steps. Method 830 can be performed by an adaptive traffic manager (e.g., adaptive traffic manager 130), and more particularly by a site detector (e.g., site detector 320) of the adaptive traffic manager. While the methods are described as being performed by site detector 320, it is appreciated that other components of adaptive traffic manager or other devices can be involved.

In step 831, site detector 320 generates a second key using the determined domain name. Any suitable method can be used. For example, similar to step 802 of FIG. 8A, the string representing the determined organization name can be converted to one or more numbers under American Standard Code for Information Interchange (ASCII), and the one or more numbers can then be used to generate the key.

In step 832, site detector 320 uses the key to query historical identification database 328 to search for an address of a child node associated with the second key. For example, referring back to FIG. 6C, site detector 320 can calculate an index from the key using one of the hash functions 673, and then access a bucket associated with the index, under domain-name-string-keyed child node mapping table 652. Site detector 320 can then determine (step 833) whether the bucket is associated with any address.

If the bucket is not associated with any address, this can indicate that none of the child nodes in historical identification database 328 stores a string that matches with the determined domain name. Such a determination can be made because, as discussed below in FIG. 8D, when a child node storing a domain name is generated, a key is also generated from the domain name and mapped to the address of the child node. Therefore, if a key generated from a domain name is used to query the database and no address is found, site detector 320 can determine that none of the child node stores a string that matches with the determined domain name. Based on this determination, site detector can then determine to update the hierarchy tree, in step 834, and proceed to step 841 of FIG. 8D to update the hierarchy tree, as to be described below. If the address is found, this can indicate that historical identification database 328 includes a child node storing a string that is identical to the determined domain name, and the hierarchy tree will not be updated, in step 835. Method 830 can then proceed to a stop after step 835.

FIG. 8D illustrates an exemplary method 840 for updating the hierarchy tree, and updating domain name mapping table 650 correspondingly, following the step 834 of FIG. 8C. Referring to FIG. 8D, it will be readily appreciated that the illustrated procedure can be altered to delete steps or further include additional steps. Method 840 can be performed by an adaptive traffic manager (e.g., adaptive traffic manager 130), and more particularly by a site detector (e.g., site detector 320) of the adaptive traffic manager. While the methods are described as being performed by site detector 320, it is appreciated that other components of adaptive traffic manager or other devices can be involved.

In step 841, site detector 320 generates a first child node to store the determined domain name. The first child node can be associated with a first address after such creation. After site detector 320 locates the hierarchy tree (e.g., after using determined organization name key to lookup the root node of the tree in step 803 of FIG. 8A), site detector 320 can traverse the hierarchy tree to find a location to add the first child node, in step 842.

FIG. 8E illustrates a method of finding the location in the hierarchy tree to add the first child node, as part of step 842. As shown in FIG. 8E, hierarchy tree 860 is generated after child node 862 is added to hierarchy tree 500 of FIG. 5A. After creating child node 862, which stores the domain name “cardapp32.abc1travel.com,” site detector 320 can compare each level of domain name of child node 862 to each level of domain names associated with child nodes 502, 503, and 504, starting from the right, to determine which child node can be an ancestor of child node 862. After determining that child node 503 can be an ancestor of child node 862, as they both share the same “abc1travel.com” first level domain name determined from the right (and Second-Level Domain Name under DNS), child node 862 is added as a child of child node 503.

Referring back FIG. 8D, after site detector 320 finds the location in step 842, it adds the first child node to the hierarchy tree and obtains the first address associated with the first child node, in step 843. In step 844, site detector 320 generates a third key from the session identifiers (e.g., session ID or session ticket). In step 845, site detector 320 associates the first address of the newly-generated first child node with the second key (generated based on the determined domain name in step 831 of FIG. 8C), and with the third key (generated based on the session identifier). For example, site detector 320 can update the domain-name-string-keyed child node mapping table 652 by adding a bucket that maps between the second key and the first address, and update either session-ID-keyed child node mapping table 656 or session-ticket-keyed child node mapping table 658 by adding a bucket that maps between the third key and the first address, depending on whether the third key is generated from a session ID or a session ticket.

After the hierarchy tree and domain name mapping table 650 is updated, additional processing may be needed to reconcile the currently determined domain name and what is currently stored. As an example, an organization may use a pool of IP addresses, and dynamically assign the IP address to different services. Therefore, the server IP address associated with a session, based on which the domain name is determined, can be identical to the IP address associated with another session from which a different domain name is determined. Steps 846 to 851 of FIG. 8D can be used to reconcile the two domain names, if they are different.

In step 846, site detector 320 generates a third key from the server IP address. In step 847, site detector 320 can query the historical identification database 328 to acquire a second address of a second child node associated with the third key. In step 848, site detector 320 determines whether the first and second addresses are identical. If the first and second addresses are identical, which indicates that the server IP address is not associated with other child nodes, the reconciliation process can be completed, and method 840 can proceed to a stop.

On the other hand, if in step 848, site detector 320 determines that the first and second address are not identical, site detector 320 can locate (step 849) the second child node associated with the second address, using domain name mapping table 650.

In step 850, site detector 320 can then locate the common ancestor of the first and second child nodes, in a process similar to what is described earlier, and then update domain name mapping table 650 to associate the common ancestor with the fourth key (generated based on the server IP address of the session) in step 851. Method 840 can proceed to a stop after step 851.

The reconciling process can prevent the server IP address from being associated with multiple domain names in the database. Using the reconciling process, the server IP address can be associated with a domain name that is representative of the hosts or servers associated with the conflicting determined domain names. This allows the server IP address to be used as a key to query for determined domain name in the future, when domain name cannot be determined from the parameters included in the handshake messages, as is discussed in more detail below.

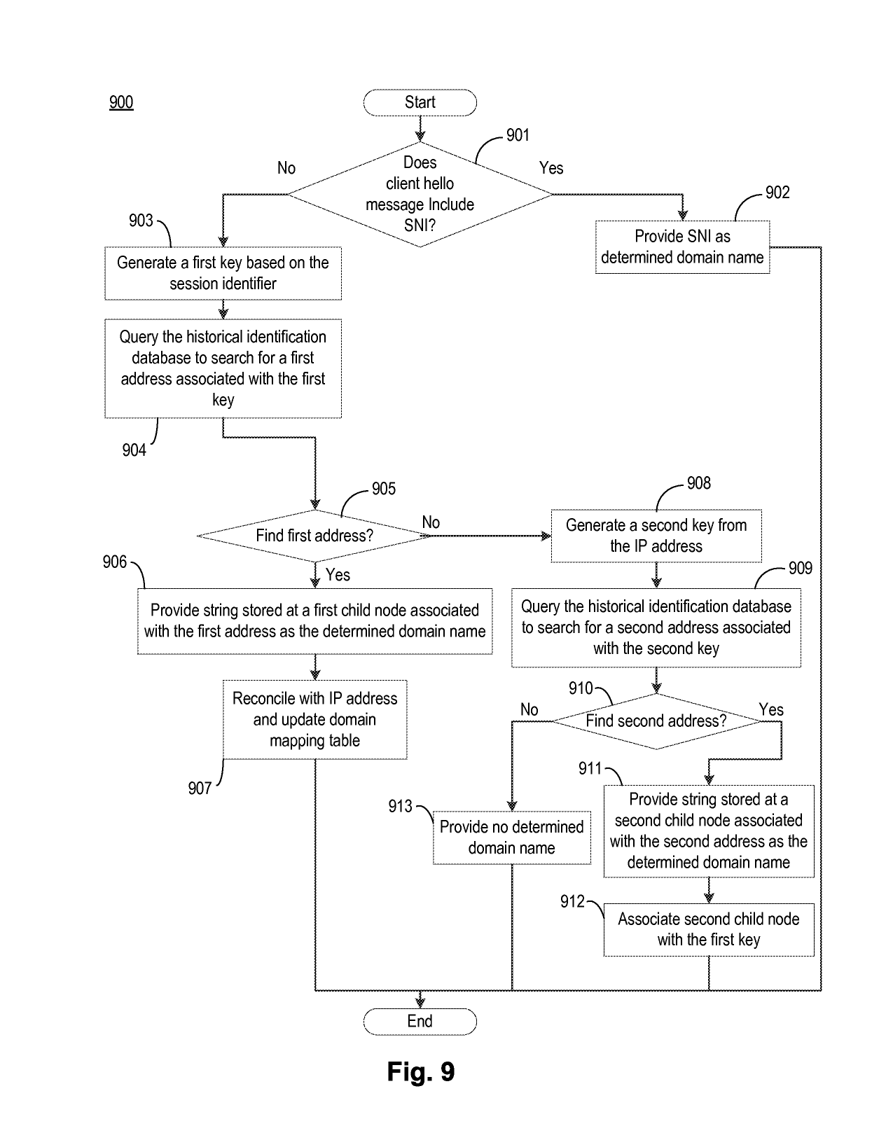

FIG. 9 illustrates an exemplary method 900 for determining domain names when resuming a SSL/TLS session. Resuming of a SSL/TLS session uses, for example, the exchange of handshake messages as described in FIG. 2B. Referring to FIG. 9, it will be readily appreciated that the illustrated procedure can be altered to delete steps or further include additional steps. Method 900 can be performed by an adaptive traffic manager (e.g., adaptive traffic manager 130), and more particularly by a site detector (e.g., site detector 320) of the adaptive traffic manager. While the methods are described as being performed by site detector 320, it is appreciated that other components of adaptive traffic manager or other devices can be involved.

In step 901, site detector 320 determines whether the client hello message associated with the session include the SNI field. If site detector 320 determines that the client hello message associated with the session include the SNI field, site detector 320 can provide the SNI as the determined domain name (in step 902).

If the SNI field is not included in any of the client hello message, site detector 320 can determine to query historical identification database 328. In step 903, site detector 320 generates a first key based on the session identifier (e.g., session ID included in client/server hello messages). In step 904, site detector 320 can query the database to search for a first address of a first child node associated with the first key, by looking up either session-ID-keyed child node mapping 656 or session-ticket-keyed child node mapping table 658 of FIG. 6A. Site detector 320 can then determine whether the first address is found (in step 905).

If the first address is found, this can indicate that a first child node storing a domain name can be located in the database with the first key. As a result, site detector 320 can acquire the string from the first child node associated with the first address, and provide the string as the determined domain name, in step 906. Site detector 320 can then, in step 907, carry out a reconciling process similar to steps 846 to 851 of FIG. 8D to detect whether the server IP address of the session is associated with other domain names. The details of the reconciling process are not repeated here.

If a match is not found, site detector 320 can generate a second key from the server IP address, in step 908. Site detector 320 can query historical identification database 328 to search for a second address of a second child node associated with the second key, in step 909. For example, site detector 320 can access server-IP-address-keyed child node mapping table 654 to search for the second address. Site detector 320 can then determine whether the second address is found (step 910).

If the second address is found, this can indicate that the second child node storing a domain name can be located in the database with the second key. As a result, site detector 320 can acquire the string from the second child node associated with the second address, and provide the string as the determined domain name, in step 911. Site detector 320 can also, in step 912, update domain name mapping table 650 by associating the first key (the key generated based on the session identifiers) with the second child node. Such an association can be performed by, for example, adding a bucket with a mapping between the first key and the second address in either session-ID-keyed child node mapping table 656 or session-ticket-keyed child node mapping table 658.

If a match cannot be found, this can indicate that none of the child nodes is associated with either the server IP address or the session identifiers. As a result, site detector 320 will provide no determined domain name, in step 913. Method 900 can proceed to a stop after either step 902, step 907, step 912, or step 913.

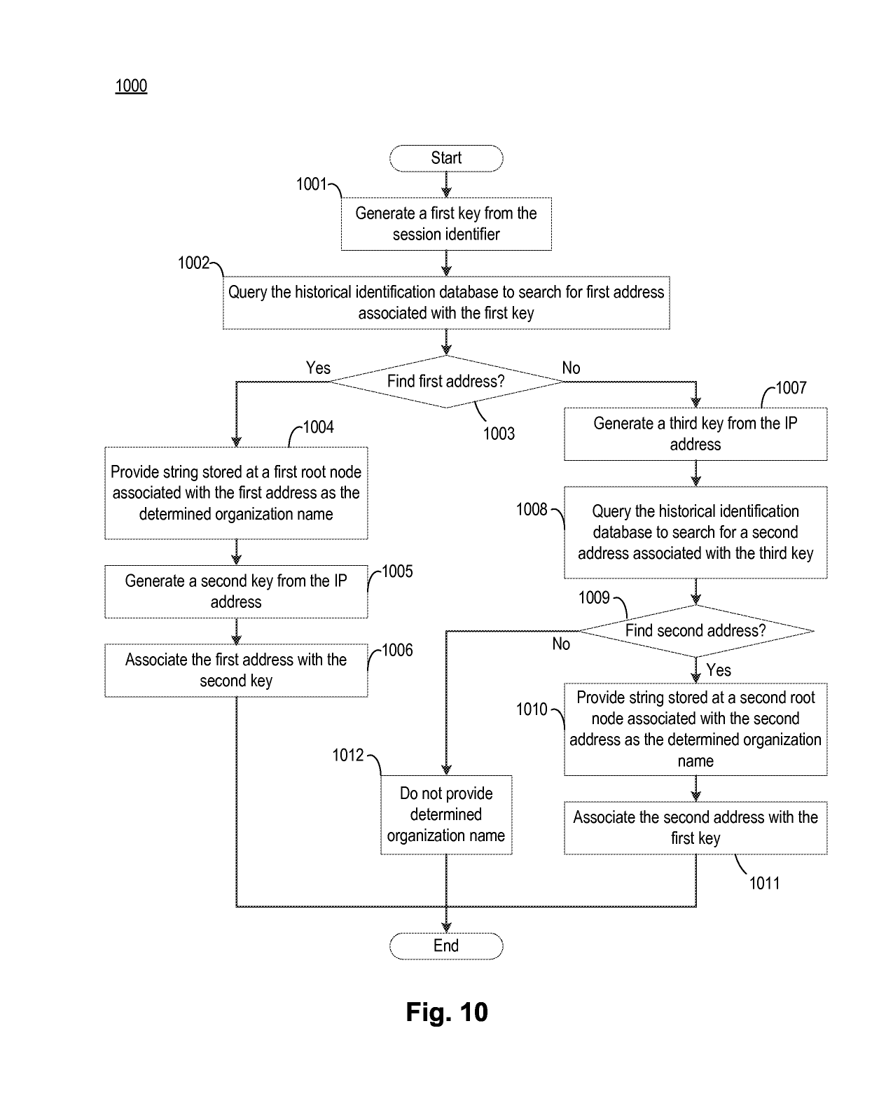

FIG. 10 illustrates an exemplary method 1000 for determining organization names when resuming a SSL/TLS session, similar to the exchange of handshake messages as described in FIG. 2B. As discussed before, during resuming of SSL/TLS session, no server certificate message is transmitted. Therefore the organization name cannot be determined from the common name field or organization field included in the server certificate message. Site detector 320 can then query the historical identification database 328 to search for previously-determined organization name. Referring to FIG. 10, it will be readily appreciated that the illustrated procedure can be altered to delete steps or further include additional steps. Method 1000 can be performed by an adaptive traffic manager (e.g., adaptive traffic manager 130), and more particularly by a site detector (e.g., site detector 320) of the adaptive traffic manager. While the methods are described as being performed by site detector 320, it is appreciated that other components of adaptive traffic manager or other devices can be involved.

In step 1001, site detector 320 generates a first key based on the session identifier (e.g. session ID of client hello message). In step 1002, site detector 320 can use the first key to query historical identification database 328 to search for a first address associated with the first key. For example, site detector 320 can use either session-ID-keyed root node mapping table 626 or session-ticket-keyed root node mapping table 628, depending on whether session ID or session ticket is used for the first key, to search for the first address. Site detector 320 can then determine whether the first address can be found (step 1003).

If the first address can be found, site detector 320 can then acquire the string stored at the a first root node associated with the first address, and provide the string as the determined organization name (step 1004). Site detector 320 can then generate a second key from the server IP address (step 1005), and associate the first address of the first root node with the second key in server-IP-address-keyed root node mapping table 624 (step 1006).

If the first address cannot be found, site detector 320 can also generate a third key from the server IP address (step 1007). Site detector 320 can use the third key to query historical identification database 328 to search for a second address associated with the third key (step 1008). For example, site detector 320 can use server-IP-address-keyed root node mapping table 624 to search for the second address. Site detector 320 can then determine whether the second address can be found (step 1009).

If the second address can be found, site detector 320 can then acquire the string stored at a second root node associated with the second address, and provide the string as the determined organization name (step 1010), and then associate the second address of the second root node with the first key (generated from session identifiers in step 1001) in either session-ID-keyed root node mapping table 626, or session-ticket-keyed root node mapping table 628 (step 1011). On the other hand, if the second address cannot be found, site detector 320 will provide no determined organization name (step 1012). After step 1006, step 1011, or step 1012, method 1000 can proceed to a stop.

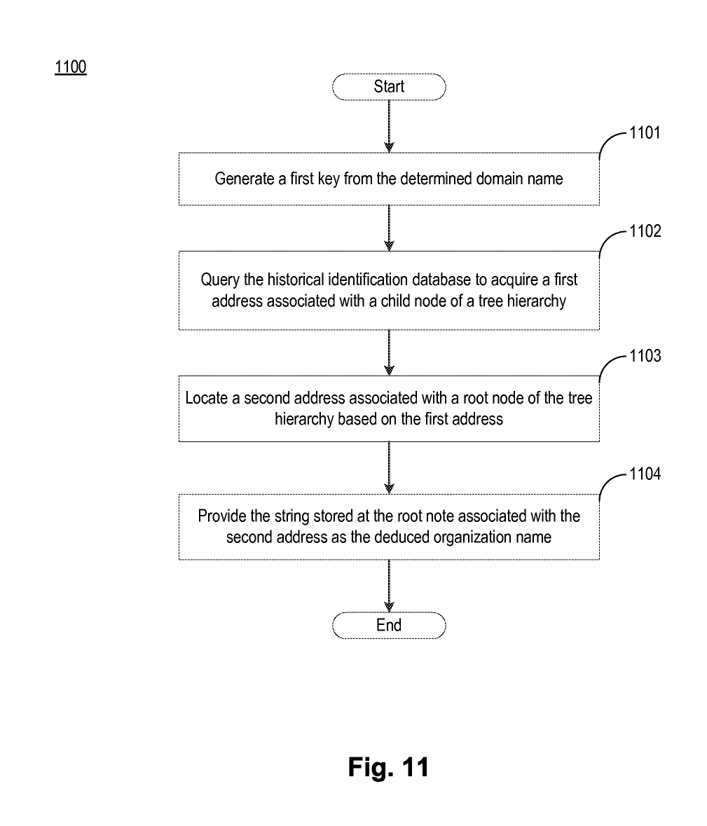

FIG. 11 illustrates an exemplary method 1100 for determining organization names when resuming a SSL/TLS session. In some situations, as discussed before, a query for the organization name using the server IP address returns no result. This can happen when the session is associated with a new server IP address which site detector 320 has not encountered before. If the SNI field of the client hello message is available, site detector 320 can use method 1100 to determine the organization name. Referring to FIG. 11, it will be readily appreciated that the illustrated procedure can be altered to delete steps or further include additional steps. Method 1100 can be performed by an adaptive traffic manager (e.g., adaptive traffic manager 130), and more particularly by a site detector (e.g., site detector 320) of the adaptive traffic manager. While the methods are described as being performed by site detector 320, it is appreciated that other components of adaptive traffic manager or other devices can be involved.

In step 1101, site detector 320 generates a first key based on a domain name determined from, for example, the SNI field of the client hello message. In step 1102, site detector 320 queries historical identification database 328 to acquire a first address of a child node of a hierarchy tree, where the first address is associated with the first key. For example, site detector 320 can access domain-name-string-keyed child node mapping table 652 to search for the first address.

In step 1103, the root node of the hierarchy tree where the child node is located can be located. For example, site detector 320 can traverse the hierarchy tree to locate the address of the root node. In some embodiments, the addresses of child nodes and the root nodes can be mapped in a separate mapping table (not shown in the figures), and site detector 320 can then locate the second address of the root node based on the first address of the child node.

In step 1104, after locating the root node, site detector 320 can acquire the string stored at the root node, and provide the string as determined organization name. After step 1104, method 1100 can proceed to an end.

In the foregoing specification, an element (e.g., adaptive traffic manager or multimedia detector and classifier) can have one or more processors and at least one memory for storing program instructions corresponding to methods 400, 700, 800, 820, 830, 840, 900, 1000, and 1100 consistent with embodiments of the present disclosure. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods can be implemented in hardware components or combinations of hardware and software such as, for example, ASICs and/or special purpose computers.

Embodiments have been described with reference to numerous specific details that can vary from implementation to implementation. Certain adaptations and modifications of the described embodiments can be made. Other embodiments can be apparent to those skilled in the art from consideration of the specification and practice of the embodiments disclosed herein. It is intended that the specification and examples be considered as exemplary only. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. An apparatus for determining at least one of a domain name and an organization name associated with a server, the apparatus comprising:
a traffic processor configured to acquire one or more handshake messages associated with establishing or resuming a secure session with the server; and
a site detector configured to:
determine whether the one or more handshake messages include one or more site textual identifiers; and
if the one or more handshake messages does not include one or more site textual identifiers:
acquire the at least one of a domain name and an organization name based on querying a historical identification database using at least one of a session identifier and an IP address associated with the server.

2. The apparatus of claim 1, wherein the site detector is configured to acquire the at least one of a domain name and an organization name based on querying a historical identification database using at least one of a session identifier and an IP address associated with the server comprises the site detector being configured to:
query the historical identification database with one or more keys generated based on the at least one of the session identifier and the IP address; and
determine the at least one of a domain name and an organization name based on a result of the querying.

3. The apparatus of claim 2, wherein the historical identification database stores at least one domain name and at least one organization name, the at least one domain name and the at least one organization name being previously determined by the site detector; wherein each of the at least one domain name and the at least one organization name is associated with at least one key generated based on one of the IP address and the session identifier.

4. The apparatus of claim 1, wherein if the one or more handshake messages include site textual identifiers, the site detector is further configured to:
determine the at least one of a domain name and an organization name associated with the server based on the one or more site textual identifiers;
store the at least one of a domain name and an organization name at the historical identification database; and
associate the at least one of a domain name and an organization name with one or more keys generated based on at least one of a session identifier and an IP address associated with the server.

5. The apparatus of claim 4 wherein the one or more handshake messages comprise a client hello message, a server certificate message, and a NewSessionTicket message;
wherein the one or more site textual identifiers include at least one of: a server name indication (SNI) field associated with the client hello message; a common name field associated with the server certificate message, a subject alternate name (SAN) field associated with the server certificate message, an organization name field associated with the server certificate message; and
wherein the session identifier includes one of: a session ID associated with the client hello message or the server hello message, and a session ticket associated with the client hello message or the NewSessionTicket message.

6. The apparatus of claim 5, wherein the site detector is configured to determine the at least one of a domain name and an organization name associated with the server based on the one or more site textual identifiers comprises the site detector being configured to:
determine whether the client hello message includes the SNI field; and
determine the domain name based on a first value associated with the SNI field, if the client hello message includes the SNI field.

7. The apparatus of claim 6, wherein if the one or more handshake messages are associated with establishing the session, and that the client hello message does not include the SNI field, the site detector is configured to determine the at least one of a domain name and an organization name associated with the server based on the one or more site textual identifiers further comprises the site detector being configured to:
determine the domain name based on a second value associated with the common name field, if the SAN field is empty, or if the second value matches at least one of one or more third values associated with the SAN field; and
determine the domain name based on a relationship between the second value and the one or more third values, if the SAN field is not empty, and if the second value does not match any of the one or more third values.

8. The apparatus of claim 4, wherein the historical identification database is organized under one or more hierarchy trees;
wherein each hierarchy tree represents an estimation of a domain hierarchy associated with an organization and includes a root node and one or more child nodes;
wherein each root node is configured to store a string representing an organization name;
wherein each child node is configured to store a string representing a domain name; and
wherein each of the root node and the one or more child nodes are associated with an address.

9. The apparatus of claim 8, wherein the site detector is configured to store the at least one of a domain name and an organization name at the historical identification database comprises the site detector being configured to:
generate a first key based on the determined organization name; and
query the historical identification database with the first key to search for an address associated with the first key.

10. The apparatus of claim 9, wherein, if the address associated with the first key is not found, the site detector is configured to store the at least one of a domain name and an organization name at the historical identification database comprises the site detector being configured to:
generate at least one of: a first root node associated with a first address to store the determined organization name, and a first child node associated with a second address to store the determined domain name; and
generate a second key based on the IP address, a third key based on the session identifier, and/or a fourth key based on the determined domain name;
and wherein the site detector is configured to associate the at least one of the determined domain name and determined organization name with one or more keys generated based on at least one of a session identifier and an IP address comprises the site detector being configured to:
associate the first address with the first key, the second key, and the third key; and/or
associate the second address with the second key, the third key, and the fourth key.

11. The apparatus of claim 9, wherein if an address associated with the first key is found, the site detector is configured to store the at least one of a domain name and an organization name at a historical identification database comprises the site detector being further configured to:
generate a second key based on the determined domain name; and
query the historical identification database with the second key to search for an address associated with the second key;
if an address associated with the second key is not found:
generate a first child node associated with a first address to store the determined domain name;
generate a third key based on the session identifier;
associate the first address with the second key and with the third key;
generate a fourth key based on the IP address;
query the historical identification database with the fourth key to acquire a second address associated with a second child node and with the fourth key;
determine whether the first address and the second address are identical; and
if the first address and the second address are not identical:
locate a third child node being a common ancestor of the first and second child nodes and being associated with a third address; and
associate the third address with the fourth key.

12. The apparatus of claim 8, wherein if the one or more handshake messages are associated with resuming the session, the site detector is configured to query the historical identification database with one or more keys generated based on the at least one of the session identifier and the IP address further comprising the site detector being configured to:
generate a first key based on the session identifier;
query the historical identification database with the first key to search for a first address associated with the first key and with a first child node;
if the first address is found, provide a string stored at the first child node as the determined domain name.

13. The apparatus of claim 12, wherein if the first address is found, the site detector is further configured to:
generate a second key based on the IP address;
query the historical identification database with the second key to acquire a second address associated with a second child node and with the second key;
determine whether the first address and the second address are identical;
if the first address and the second address are not identical:
locate a third child node that is a common ancestor of the first and second child nodes and is associated with a third address; and
associate the third address with the second key.

14. The apparatus of claim 12, wherein if the first address is not found, the site detector is configured to:
generate a second key based on the IP address;
query the historical identification database with the second key to search for a second address associated with a second child node and with the second key;
if the second address is found:
provide a string stored at the second child node as the determined domain name; and
associate the second address with the first key.

15. The apparatus of claim 8, wherein if the one or more handshake messages are associated with resuming the session, the site detector is configured to query the historical identification database with one or more keys generated based on the at least one of the session identifier and the IP address further comprising the site detector being configured to:
generate a first key based on the session identifier;
query the historical identification database with the first key to search for a first address associated with the first key and with a first root node; and
if the first address is found:
provide a string stored at the first root node as the determined organization name;
generate a second key based on the IP address; and
associate the first address with the second key.

16. The apparatus of claim 15, wherein if the first address is not found, the site detector is further configured to:
generate a third key based on the IP address; and
query the historical identification database with the third key to search for a second address associated with a second root node and with the third key;
if the second address is found:
provide a string stored at the second root node as the determined organization name; and
associate the second address with the first key.

17. The apparatus of claim 8, wherein the site detector is configured to determine the at least one of the domain name and the organization name associated with the server based on the one or more site textual identifiers further comprising the site detector being configured to:
generate a first key based on the determined domain name;
query the historical identification database with the first key to acquire a first address associated with a child node of a hierarchy tree, the first address being associated with the first key;
locate, based on the first address, a second address associated with a root node of the hierarchy tree;
locate a second address associated with a root node of the hierarchy tree based on the first address; and
provide a string stored at the root node as the determined organization name.

18. A computer-implemented method for determining at least one of a domain name and an organization name associated with a server, the method being performed by one or more processors, the method comprising:
acquiring one or more handshake messages associated with establishing or resuming a secure session with the server;
determining whether the one or more handshake messages include one or more site textual identifiers; and
if the one or more handshake messages does not include one or more site textual identifiers:
acquiring the at least one of a domain name and an organization name based on querying a historical identification database using at least one of a session identifier and an IP address associated with the server.

19. The computer-implemented method of claim 18, wherein if the one or more handshake messages include site textual identifiers, further comprising:
determining at least one of a domain name and an organization name associated with the server based on the one or more site textual identifiers;
storing the at least one of a domain name and an organization name at the historical identification database; and
associating the at least one of a domain name and an organization name with one or more keys generated based on at least one of a session identifier and an IP address associated with the server.

20. The computer-implemented method of claim 19, wherein the historical identification database is organized under one or more hierarchy trees;
wherein each hierarchy tree represents an estimation of a domain hierarchy associated with an organization and includes a root node and one or more child nodes;
wherein each root node is configured to store a string representing an organization name;
wherein each child node is configured to store a string representing a domain name; and
wherein each of the root node and the one or more child nodes are associated with an address.

21. The computer-implemented method of claim 20, wherein the storing the at least one of a domain name and an organization name at the historical identification database comprises:
generating a first key based on the determined organization name; and
querying the historical identification database with the first key to search for an address associated with the first key.

22. The computer-implemented method of claim 21, wherein, if the address associated with the first key is not found, the storing the at least one of a domain name and an organization name at the historical identification database comprises:
generating at least one of: a first root node associated with a first address to store the determined organization name, and a first child node associated with a second address to store the determined domain name; and
generating a second key based on the IP address, a third key based on the session identifier, and/or a fourth key based on the determined domain name;
and wherein the associating the at least one of a domain name and an organization name with one or more keys generated based on at least one of a session identifier and an IP address associated with the server comprises:
associating the first address with the first key, the second key, and the third key; and/or
associating the second address with the second key, the third key, and the fourth key.

23. The computer-implemented method of claim 21, wherein if an address associated with the first key is found, the storing the at least one of a domain name and an organization name at the historical identification database comprises:
generating a second key based on the determined domain name; and
querying the historical identification database with the second key to search for an address associated with the second key;
if an address associated with the second key is not found:
generating a first child node associated with a first address to store the determined domain name;
generating a third key based on the session identifier;
associating the first address with the second key and with the third key;
generating a fourth key based on the IP address;
querying the historical identification database with the fourth key to acquire a second address associated with a second child node and with the fourth key;
determining whether the first address and the second address are identical; and
if the first address and the second address are not identical:
locating a third child node being a common ancestor of the first and second child nodes and being associated with a third address; and
associating the third address with the fourth key.

24. The computer-implemented method of claim 20, wherein if the one or more handshake messages are associated with resuming the session, the querying the historical identification database with one or more keys generated based on the at least one of the session identifier and the IP address comprises:
generating a first key based on the session identifier;
querying the historical identification database with the first key to search for a first address associated with the first key and with a first child node;
generating a second key based on the IP address;
if the first address is found:
providing a string stored at the first child node as the determined domain name;
if the first address is not found:
querying the historical identification database with the second key to search for a third address associated with a third child node and with the second key;
if the third address is found:
providing a string stored at the third child node as the determined domain name.

25. The computer-implemented method of claim 20, wherein if the one or more handshake messages are associated with resuming the session, the querying the historical identification database with one or more keys generated based on the at least one of the session identifier and the IP address comprises:
generating a first key based on the session identifier;
querying the historical identification database with the first key to search for a first address associated with the first key and with a first root node; and
if the first address is found:
providing a string stored at the first root node as the determined organization name;
generating a second key based on the IP address; and
associating the first address with the second key.

26. A non-transitory computer readable storage medium storing instruction that are executable by one or more processors to cause the one or more processors to perform a method for determining at least one of a domain name and an organization name associated with a server, the method comprising:
acquiring one or more handshake messages associated with establishing or resuming a secure session with the server;
determining whether the one or more handshake messages include one or more site textual identifiers; and
if the one or more handshake messages does not include one or more site textual identifiers:
acquiring the at least one of a domain name and an organization name based on querying a historical identification database using at least one of a session identifier and an IP address associated with the server.

27. The computer readable storage medium of claim 26, wherein if the one or more handshake messages include site textual identifiers, further comprising:
determining at least one of a domain name and an organization name associated with the server based on the one or more site textual identifiers;
storing the at least one of a domain name and an organization name at the historical identification database; and
associating the at least one of a domain name and an organization name with one or more keys generated based on at least one of a session identifier and an IP address associated with the server.

28. The computer readable storage medium of claim 27, wherein the historical identification database is organized under one or more hierarchy trees;
wherein each hierarchy tree represents an estimation of a domain hierarchy associated with an organization and includes a root node and one or more child nodes;
wherein each root node is configured to store a string representing an organization name;
wherein each child node is configured to store a string representing a domain name; and
wherein each of the root node and the one or more child nodes are associated with an address.

29. The computer readable storage medium of claim 28, wherein the storing the at least one of a domain name and an organization name at the historical identification database comprises:
generating a first key based on the determined organization name; and
querying the historical identification database with the first key to search for an address associated with the first key.

30. The computer readable storage medium of claim 29, wherein, if the address associated with the first key is not found, the storing the at least one of a domain name and an organization name at the historical identification database comprises:
generating at least one of: a first root node associated with a first address to store the determined organization name, and a first child node associated with a second address to store the determined domain name; and
generating a second key based on the IP address, a third key based on the session identifier, and/or a fourth key based on the determined domain name;
and wherein the associating the at least one of a domain name and an organization name with one or more keys generated based on at least one of a session identifier and an IP address associated with the server comprises:
associating the first address with the first key, the second key, and the third key; and/or
associating the second address with the second key, the third key, and the fourth key.

31. The computer readable storage medium of claim 29, wherein if an address associated with the first key is found, the storing the at least one of a domain name and an organization name at the historical identification database comprises:
generating a second key based on the determined domain name; and
querying the historical identification database with the second key to search for an address associated with the second key;
if an address associated with the second key is not found:
generating a first child node associated with a first address to store the determined domain name;
generating a third key based on the session identifier;
associating the first address with the second key and with the third key;
generating a fourth key based on the IP address;
querying the historical identification database with the fourth key to acquire a second address associated with a second child node and with the fourth key;
determining whether the first address and the second address are identical; and
if the first address and the second address are not identical:
locating a third child node being a common ancestor of the first and second child nodes and being associated with a third address; and
associating the third address with the fourth key.

32. The computer readable storage medium of claim 28, wherein if the one or more handshake messages are associated with resuming the session, the querying the historical identification database with one or more keys generated based on the at least one of the session identifier and the IP address comprises:
generating a first key based on the session identifier;
querying the historical identification database with the first key to search for a first address associated with the first key and with a first child node;
generating a second key based on the IP address;
if the first address is found:
providing a string stored at the first child node as the determined domain name;
if the first address is not found:
querying the historical identification database with the second key to search for a second address associated with a second child node and with the second key;
if the second address is found:
providing a string stored at the second child node as the determined domain.

33. The computer readable storage medium of claim 28, wherein if the one or more handshake messages are associated with resuming the session, the querying the historical identification database with one or more keys generated based on the at least one of the session identifier and the IP address comprises:
generating a first key based on the session identifier;
querying the historical identification database with the first key to search for a first address associated with the first key and with a first root node; and
if the first address is found:
providing a string stored at the first root node as the determined organization name;
generating a second key based on the IP address; and
associating the first address with the second key.
